(19) United States
(12) Patent Application Publication
(10) Pub. No.: US 2025/0019972 A1
(43) Pub. Date: Jan. 16, 2025

(54) PANEL, COMPOSITION FOR FORMING A COATING LAYER, AND METHOD OF MANUFACTURING A PANEL

(71) Applicant: CFL Holding Limited, Hong Kong (HK)

(72) Inventors: Thomas Luc Martine BAERT, Sint-Martens-Latem (BE); Tom VAN POYER, Jiaxing (CN); Sven BOON, Jiaxing (CN)

(73) Assignee: CFL Holding Limited, Hong Kong (HK)

(21) Appl. No.: 18/675,978

(22) Filed: May 28, 2024

(30) Foreign Application Priority Data
Jul. 12, 2023 (NL) 2035354

(51) Int. Cl. E04F 13/08; B05D 5/02; B05D 7/00; E04F 13/18

(52) U.S. Cl. CPC E04F 13/0875; B05D 5/02; B05D 7/56; E04F 13/0894; E04F 13/18; B05D 2203/30

(57) ABSTRACT

The present invention relates to a panel, in particular a floor panel or wall panel, comprising a core layer comprising a mineral filler, a polymeric binder, and optionally a plasticizer; and a coating layer located on a bottom surface of the core layer. The invention further relates to a composition for forming a coating layer. The invention further relates to a method of manufacturing a panel, comprising providing a core layer comprising at least one mineral filler and at least one polymeric binder, applying a composition to at least part of a bottom surface of the core layer, and at least partially crosslinking the composition to obtain a coating layer.

### CROSS REFERENCE TO RELATED APPLICATION

This application claims priority under 35 U.S.C. § 119 to Netherlands Patent Application No. 2035354, filed Jul. 12, 2023, which is incorporated herein by reference in its entirety.

### FIELD OF THE INVENTION

The present invention relates to a panel. The invention further relates a method of manufacturing a panel.

### BACKGROUND

Extruded resilient floor or wall panels typically comprise a core containing binders such as thermoplastic elastomers or flexible polymers. These binders are often thermoplastic polymers that have desirable properties, such as resistance against moisture, heat, and impact. Common binders are polyvinylchloride (PVC) and polypropylene (PP) or other thermoplastic polymers as they are easy to process in extrusion, calendaring, and thermolamination processes.

In addition to binders, extruded resilient floor or wall panels typically can comprise inorganic mineral fillers. These inorganic mineral fillers are usually added to the core of the extruded resilient floor or wall panel, and impart benefits such as increased thermal stability, increased rigidity and toughness, and an increased modulus of elasticity and hardness. Flame and smoke retardant properties can also be imparted by including certain inorganic mineral fillers in the core. However, the addition of inorganic mineral filler to the core is only beneficial up to a certain level, upper limit or saturation point. This so-called saturation point represents a point where the weight ratio between the binder and the inorganic mineral filler can no longer be increased without negatively affecting the panel properties. Past this point, differences in interfacial compatibility and adhesion between the inorganic mineral filler and the binder, which is typically a thermoplastic polymer, as well as an agglomeration of the inorganic mineral filler cause deterioration in tensile strength, impact strength, and compressive strength of the floor or wall panel. In addition, a steep decline in processing performance of the composition that is to be extruded to form the resilient floor, is observed. As inorganic mineral fillers are relatively inexpensive, increasing inorganic mineral filler content of the core decreases product costs and can provide benefits as described above. A weight ratio of at least 2.5:1 mineral filler to thermoplastic binder is preferred and even higher mineral filler to binder weight ratios can be desirable, such as 3:1, and even up to a saturation point of 3.5:1. The saturation point is dependent on the type and properties of inorganic mineral filler and the type of binder, and as such may differ from 3.5:1. To further increase the weight ratio between inorganic filler mineral filler and binder beyond this saturation point, it is known to add large quantities of plasticizers to a mixture of inorganic mineral filler and binder, to improve the core's plasticity during extrusion and to improve its flexibility and durability in use. The use of plasticizers allows to further increase the weight ratio of inorganic mineral filler to binder to 4:1 or even up to 4.5:1. Other additives such as waxes, lubricants, and coupling agents can also be utilized to improve the processibility of these high-mineral content polymeric compositions.

In general, a plasticizer content lies in the range of 2-3% by total weight of the panel. The addition of plasticizer is even more crucial when producing flexible resilient flooring for glue down installation, commonly called Luxury Vinyl Tile (LVT), through an extrusion process. The flexibility and deflection of LVT panels can be tested according to ISO 24344 or ASTM F137. LVT needs to be flexible enough to be bent 180° around a mandrel having a diameter of 25/38 mm when tested according to ISO 24344 or ASTM F137. To extrude flexible LVT with a relatively high mineral content, i.e., a mineral filler to thermoplastic binder weight ratio of at least 3.5:1, the plasticizer content should be increased to at least 4% by total weight of the panel, even up to 6% or 8% by total weight of the panel with increasing mineral content.

Nevertheless, the combination of a binder such as a thermoplastic elastomer or a flexible polymer binder, for example PVC or PP, a weight ratio of inorganic mineral filler to binder exceeding 3.5:1, and at least one plasticizer, poses multiple technical challenges. At least one mineral filler may comprise magnesium oxide, magnesium carbonate, magnesium oxysulphate, magnesium oxychloride cement (MOC), magnesium chloride (MgCl2), magnesium sulphate (MgSO4), Sorel cement, fiber cement, MOS cement, limestone, calcium carbonate, calcite mineral, stone, chalk, clay, calcium silicate and/or talc.

A first challenge is a relatively low surface energy of 24-32 dyn/cm of the core of a panel when the core comprises thermoplastic elastomers and/or flexible polymers. A surface energy of this range, measured according to ASTM D7490-13, is insufficient to allow for proper wetting, application, and adhesion of adhesives. One solution to this is to subject the back surface of the core to a corona or plasma treatment prior to the application of adhesive, which can achieve a limited increase of surface energy for at least a certain time. However, as this surface energy increase is limited in time, it is not a suitable solution for panels intended for glue down installation as the adhesive is applied when installing the panels, which could be weeks or months after production. Resilient panels with low surface energy are also expected to cause issues with adhesion and adhesive compatibility and are a main contributing factor or root cause in installation failures and quality complaints.

Plasticizers are low-molecular weight processing aids that improve processability. As touched upon above, an increase in mineral content of a core of a panel typically requires a corresponding increase in plasticizer content of the core. Plasticizers can be classified as internal plasticizers and external plasticizers. External plasticizers do not react with polymers. These are different from internal plasticizers which react with and make up part of a polymer chain. External plasticizers function by reducing the cohesive forces between polymer chains, and do not bond with these but are merely attracted to them through Van der Waals forces, weak intermolecular cohesive forces that occur between molecules due to temporary fluctuations in electron density. Plasticizers can weaken these cohesive forces by disrupting the intermolecular interactions between the chains, thereby making the polymer matrix more flexible and less brittle.

Plasticizer migration can occur when the weak intermolecular forces between the plasticizer and polymeric chains are overcome by other forces, or due to differences in concentration between the plasticizer within the polymer matrix and the surrounding or adjacent material. Exposure to heat can increase the speed of this migration as it increases the kinetic energy of the molecules, causing them to move more rapidly, making it easier to overcome the Van der Waals forces. Additionally, heat can also and simultaneously increase the permeability of the polymer matrix, allowing the plasticizers to migrate out of the material more easily. A plasticized extruded core present in a standard heterogeneous resilient floor or wall panel will therefore exhibit plasticizer migration to varying degrees.

A second challenge is then due to the attraction adhesives exert on plasticizers, resulting in the liquification of the adhesive layer. This attraction is due to the strongly polar or ionic nature of adhesives which attract, and interact with, polar or ionic functional groups on the plasticizer molecules. As the adhesive between panel layers liquefies, adherence between the layers is lost, and the layers start to separate or delaminate. Plasticizer migration may therefore directly affect the adhesive layer composition, and consequently lead to quality concerns. In the case of resilient decorative panels directly adhered to the substrate by means of an adhesive, this could mean catastrophic delamination. In the case of resilient wall panels adhered to a vertical substrate, this delamination can even cause safety concerns. Even in the case of a pre-attached or separately installed underlayment present underneath the floor panel, plasticizer migration could lead to the destruction of the polymeric structure of the underlayment, which might be weakened, or even break down or disintegrate. There is a market demand for more sustainable plasticizers, moving away from harmful but highly compatible orthophthalate plasticizers to less compatible terephthalate plasticizers, and even bioplasticizers. As such, plasticizer migration in panels represents a quality and additionally a safety risk that need to be addressed.

A third challenge is that the application of curable coatings on a panel can cause warpage of the panel, especially on panels comprising a high plasticizer content. Due to shrinkage of coatings during the curing process of the coating, the panel is pulled together, resulting in a panel that is not flat. Subsequent installation of such a warped panel on a floor or wall requires additional adhesive, to compensate for the curvature of the panel, and might lead to gapping and height differences between panels. The final adherence of the panel to the floor or wall is therefore not optimal.

It is therefore an object of the invention to provide a panel suitable for an enduring and strong adherence to a floor or wall.

### DETAILED DESCRIPTION

In a first aspect, the invention provides thereto a panel, in particular a floor panel, wall panel or building panel, comprising: at least one core layer comprising at least one mineral filler, at least one polymeric binder, and optionally at least one plasticizer; and at least one coating layer located on a bottom surface of at least one core layer; wherein at least one coating layer preferably comprises an at least partly crosslinked polymer which is preferably impermeable to the plasticizer.

At least one coating layer, located on the bottom surface of the core layer provides a barrier at the bottom surface of the core layer that stops plasticizer from migrating through the coating layer. As such, when the panel is adhered to a substrate or surface with an adhesive, the adherence is maintained over a longer period of time, as the adhesive does not liquefy under the influence of the plasticizer. A mineral is a compound classified as a mineral by the International Mineralogical Association (The New IMA List of Minerals, updated May 2023). A mineral filler is thus a mineral that serves to fill another compound or material.

A plasticizer is a compound added to a material to soften the material and to increase its flexibility. Plasticizers can increase plasticity and decrease viscosity of a material. Depending on the size of the plasticizer, it is advantageous that the crosslinked polymer in the coating layer has a certain crosslink density to prevent migration of the plasticizer through the coating layer. Crosslink density is defined as the number of effective cross-links per unit volume or unit mass, in inverse relation to the molecular weight between cross-links (Mc).

Preferably, at least partially crosslinked polymer comprises a crosslinked polymeric network. Crosslinked polymeric networks comprise polymer chains that are held together with covalent bonds, and as such, form a network.

According to the present invention, the coating layer comprises an at least partially crosslinked polymer. The coating layer is applied to at least part of the bottom surface of the core layer. Prevention of migration of at least one plasticizer from the core layer through the coating layer, is achieved by the at least partly crosslinked polymer comprising a network of crosslinks and voids, defined by a crosslink density and a corresponding average void size. The crosslink density XLD of the at least partially crosslinked polymer in the coating layer according to the invention translates to the crosslinked polymeric matrix forming a plurality of voids having an average void diameter (Vdia).

A high crosslink density results in a relatively small average void diameter, a high volumetric density, a rigid cured composition, and a high shrinking rate. A low crosslink density results in a relatively large average void diameter, a low volumetric density, a flexible cured composition, and a small shrinking rate. Crosslinking density can be expressed as a percentage between 0% (no crosslinks) and 100% (fully crosslinked).

The crosslinked polymer is preferably formed by polymerizing and crosslinking at least one oligomer and at least one monomer by means of a photoinitiator. Preferably, the at least one monomer is an acrylic monomer. Assuming a typical molecular weight of the acrylic monomer unit to be around 100 g/mol, the density of the crosslinked polymer is estimated to be around 1.2 g/cm³. The void diameters for crosslink densities of 40%, 50%, 60%, and 70% then fall in the range of:
40% crosslink density: 50-80 nm
50% crosslink density: 40-60 nm
60% crosslink density: 30-50 nm
70% crosslink density: 0.1-0.4 nm.

A 60%-70% crosslink density was experimentally and theoretically found to be a threshold crosslink density above which the average void diameter decreases exponentially. Through a controlled reduction of the average void diameter of the crosslinked polymer in the coating layer, an inert mechanical barrier can be formed through which plasticizer molecules are unable to migrate, without compromising the shrinking rate and rigidity or brittleness of the crosslinked polymer, and as such the coating layer.

In line with the above, the at least partially crosslinked polymer may have a crosslinking density (XLD) of at least 50%, more preferably at least 60%, most preferably at least 65%. In particular, the XLD can range between 60% and 75%, such as 65% to 70%. As a result, the crosslinked polymer will exhibit an optimal plasticizer sealing effect which can be measured through the plasticizer migration rate from the core layer through the at least one crosslinked polymer coat, which, when measured according to ISO 177:2016, is less than 0.1, more preferably less than 0.01 mg/cm². The average diameter of voids within this crosslinked polymer, or crosslinked polymer network, is preferably less than 3 nm, more preferably less than 1.5 nm, most preferably less than 1 nm. Specifically, the average void diameter within the crosslinked polymer matrix is most preferably less than the average diameter of the at least one plasticizer. As such, the functioning of the crosslinked polymer and/or coating layer as a barrier or sealing layer which mechanically/physically impedes the diffusion/migration of the plasticizer to other layers is enhanced.

Another way to quantitate the amount of crosslinking in a polymer network is to quantify the number of remaining double bonds per molecular weight. Bifunctional methacrylates for example, are able to polymerize and form crosslinked three-dimensional polymer structures. The crosslinking of these structures can be identified by quantifying the remaining double bonds after crosslinking, or by the crosslink density (XLD). Typically, about 5-10 double bonds in a polymer of 1000 g/mol remain after crosslinking. In general, this corresponds to about 50-70% of the double bonds being utilized for crosslinking. The number of double bonds available for crosslinking is dependent on the polymer itself.

Preferably, the crosslinked polymer has a crosslink density in a range of 0.01-0.1 mol/g, preferably from 0.02-0.05 mol/g, more preferably from 0.025-0.035 mol/g, most preferably from 0.028-0.032 mol/g³, in particular measured according to ASTM D2765-16. Crosslink densities can be expressed in moles per unit weight or moles per unit volume. If the crosslinked polymer in the plasticizer sealing layer or coating layer is an acrylate polymer, its molecular weight typically lies in the range of 10000-50000 g/mol.

Preferably, the crosslinked polymeric network comprises a plurality of voids, and an average void diameter is preferably smaller or equal to twice a radius of gyration (Rg) of the plasticizer, or diameter of gyration. This effectively allows the crosslinked polymeric network to block plasticizer migration, without becoming brittle or inflexible. The diameter of gyration for a molecule, such as a plasticizer, is defined by the distribution of atoms around its centre of gravity. The diameter of gyration is given by the root-mean-square distance of the segments of a molecule from its centre of mass. For polymers, it can be a measure of size. This diameter of gyration of a molecule depends among others on the molecular weight, its structure (e.g., whether or not it is branched or crosslinked), and whether the molecule is swollen by a solvent.

Plasticizers can have a linear or cyclic structure, but their molecular weight is typically limited to the range of 100-3000 g/mol, and their diameter (i.e., 2 times their radius of gyration) typically ranges between 0.3 and 10 nm. A number of examples of plasticizers with their molecular weight (ranges) and void diameter (expressed as twice the radius of gyration) is given in Table 1.

TABLE 1
Plasticizer weights and diameters.

| | Molecular weight | Diameter |
|---|---|---|
| Plasticizer | (g/mol) | (nm) |
| Citrate esters | 250-1000 | 0.3-1.5 |
| Phthalate esters | 200-1000 | 0.3-1.5 |
| Benzoate esters | 200-500 | 0.3-1.5 |
| Adipate esters | 200-600 | 0.3-1.5 |
| Trimellitate esters | 400-1000 | 0.3-1.5 |
| Castor oil | 900-1000 | 0.5-2 |
| Dioctyl phthalate (DOP) | 390 | 2.7 |
| Bis(2-ethylhexyl) phthalate (DEHP) | 390 | 2.7 |
| Diisononyl phthalate (DINP) | 418 | 1.3 |
| Diisodecyl phthalate (DIDP) | 446 | 1.4 |
| Dioctyl terephthalate (DOTP) | 390 | 1.2 |
| Epoxidized soybean oil (ESBO) | 950-3000 | 3-10 |
| Triethyl citrate (TEC) | 276 | 0.9 |
| Triglycerides (oil) | — | 26-240 |
| Citrate esters | 192-404 | 0.5-1.5 |
| Acetyl tributyl citrate (ATBC) | 402 | 0.5-1.5 |
| Glycerol esters | 172-290 | 0.5-1.5 |
| Isosorbide diesters | 404-480 | 0.5-1.5 |
| Lactates | 118-146 | 0.3-1.0 |
| Trimellitates | 310-710 | 0.5-2 |
| Succinate esters | 202-426 | 0.5-1.5 |

Preferably, a plasticizer migration rate through the coating layer, in particular a plasticizer migration rate of the plasticizer, measured according to ISO 177:2016 is less than 0.01 mg/cm², more preferably less than 0.005 mg/cm², most preferably less than 0.001 mg/cm². In line therewith, the coating layer is substantially impervious to the plasticizer.

In an embodiment, a weight ratio of the mineral filler to the polymeric binder is at least 3.5:1, preferably at least 4.0:1, and most preferably at least 4.5:1. The relatively high mineral filler content has a positive effect on wear resistance of the panel. However, mineral fillers are relatively brittle. In order for the panel to be sufficiently flexible, a relatively high plasticizer content is required. In line therewith, a weight percentage of the plasticizer is at least 4 wt. %, preferably at least 6 wt %, more preferably at least 8 wt. %, based on total weight of the core layer. The coating layer located at the bottom surface of the core layer prevents the plasticizer from migrating out of the core. In particular, when the panel is adhered to a surface, such as a floor, via an adhesive layer, the plasticizer in the core layer is prone to migrate towards the adhesive layer. The coating layer prevents this migration.

The binder may comprise a thermoplastic elastomer, a polymer having a glass transition temperature below 0° C., measured according to ISO 6721-11:2019, a biopolymer, synthetic resin, or any combination thereof. A thermoplastic is a polymer that softens and becomes pliable upon heating and solidifies upon cooling. The process of heating and cooling a thermoplastic and the associated transition from a pliable form to a solid form can be repeated almost indefinitely. An elastomer is a material comprising polymer chains that enable the elastomer to recover its shape after deformation. The thermoplastic elastomer may be selected from polypropylene (PP), polyethylene terephthalate (PET), polyvinyl chloride (PVC), chlorinated polyvinyl chloride (CPVC), chlorinated polyethylene (CPE), or any combination thereof. The thermoplastic elastomer and the mineral filler should preferably be combinable to create a homogeneous melt prior to extrusion. The plasticizer is preferably evenly distributable throughout such a melt.

It is conceivable that the at least partially crosslinked polymer may comprise at least one carboxyl functional group and/or at least one amine functional group capable of reacting with the plasticizer. These functional groups can react with plasticizers to form covalent bonds, thus reducing mobility of the plasticizer. This is particularly advantageous in the case where a variance in void diameter of the crosslinked polymer exists, and at least part of the voids has a diameter, expressed as twice the radius of gyration of the plasticizer, exceeding the average diameter of the plasticizer. The capability of the at least partially crosslinked polymer to react with the plasticizer is a failsafe mechanism that ensures that the coating layer impedes the diffusion and migration of the plasticizer through the coating layer to other layers, such as an adhesive layer.

In contrast with the above, the crosslinked polymer may be inert to the at least one plasticizer. It can be advantageous that the crosslinked polymer does not react with the at least one plasticizer, such that the structure of the crosslinked polymer is maintained, and that plasticizer molecules are not extracted from the core layer. When the plasticizer molecules remain in the core layer, the panel retains its flexibility. This is particularly advantageous when a variance in void diameter is relatively low, for example wherein a void diameter ranges between the radius of gyration of the plasticizer and three times the radius of gyration of the plasticizer. In line therewith, the plasticizer may be an external plasticizer.

The plasticizer may be selected from diisononyl phthalate (DINP), diisodecyl phthalate (DIDP), diethylhexyl phthalate (DEHP), dibutyl phthalate (DBP), butyl benzyl phthalate (BBP), di(2-ethylhexyl) adipate (DEHA), di(2-ethylhexyl) sebacate (DOS), di(2-ethylhexyl) terephthalate (DOTP), diisononyl cyclohexane-1,2-dicarboxylate (DINCH), triethyl citrate (TEC), di(2-ethylhexyl) phthalate (DEHP), di-n-octyl phthalate (DNOP), diisobutyl phthalate (DIBP), di-n-hexyl phthalate (DNHP), diethyl phthalate (DEP), dicyclohexyl phthalate (DCHP), diethylene glycol dibenzoate (DEDB), epoxidized soybean oil (ESBO), citrates, citrate esters, castor oil derivatives, epoxidized vegetable oils, succinic acid esters, tartaric acid, sorbitol, polyethylene glycol, starch, epoxidized soybean oil (ESBO), tributyl citrate (TBC), acetyl tributyl citrate (ATBC), triethyl citrate A (TEC-A), triclocarban (TCC), bis(2-ethylhexyl) maleate, bis(2-ethylhexyl) fumarate, DOML (linseed oil), DOP (castor oil based), DEHT (castor oil), GEFA, ELO, ESO, EVO, ELOV, ELOVAT, DOSA, DOA, DIDA, DES, DBS, PEG, Lactic Acid, Oleic acid, PPG, PES, Paraffinic oils, naphthenic oils, esters, or any combination thereof. Any other type of plasticizer could also be used.

In an embodiment, the coating layer comprises at least one coupling agent. The coupling agent enables the coating layer to be adhered to another surface via, for example, an adhesive layer. The coupling agent is preferably added to an outer surface of the coating layer for optimally enhancing the adherence capabilities of the coating layer. In particular, the coupling agent comprises at least one organosilane. Organosilanes are molecules having at least a single covalent bond between a silicon atom and a carbon atom within the molecule. In particular, the chemical structure of organosilanes is R₍₄₋ₙ₎—Si—(R′X)ₙ, wherein n=1 or 2; X is an organofunctional group, such as vinyl, amino, methacryl, epoxy, or any other functional groups. X can be different functional groups when n>1. An organofunctional group is the same as an organic functional group, i.e., a functional group comprising at least one carbon atom. Organosilanes can form a bridging molecule attached to the coating layer, improving adhesion of the coating layer to another layer. As such, organosilanes are particularly suitable additives for the coating layer as these compounds further increase the surface energy of the coating layer, in particular a UV-curable plasticizer-resistant coating layer, and as such improve its adhesive properties. The increased surface energy of the coating layer increases its receptiveness to bonding with other materials, thereby promoting a better adhesion of the panel with the coating layer to other materials via an adhesive layer, through the formation of covalent bonds of the organosilane and the coating layer.

Preferably, a weight percentage of the at least one coupling agent is in the range of 0.5-5.0 wt. %, preferably 1.0-4.0 wt. %, more preferably 2.0-3.0 wt. %, most preferably 2.3-2.7 wt. %, based on total weight of the coating layer. These weight percentages were experimentally found to improve adhesion, surface wetting of the coating layer in an uncured condition, and an increased surface energy of the coating layer in a cured condition, making the coating layer more receptive to bonding with other materials.

The at least one coupling agent may be selected from aminosilanes, methacryloyx silanes, epoxy silanes, vinyl silanes, 3-Aminopropyltriethoxysilane, N-(2-Aminoethyl)-3-aminopropyltrimethoxysilane, N-(2-Aminoethyl)-3-aminopropylmethyldimethoxysilane, N-(2-Aminoethyl)-3-aminopropyltriethoxysilane, N-(6-Aminohexyl)aminopropyltrimethoxysilane, 3-Methacryloxypropyltrimethoxysilane, 3-Methacryloxypropyltriethoxysilane, 3-Methacryloxypropylmethyldimethoxysilane, 3-Methacryloxypropylmethyldiethoxysilane, 3-Methacryloxypropylphenyldimethylsiloxane, 3-Glycidoxypropyltrimethoxysilane, 3-Glycidoxypropylmethyldiethoxysilane, 3-Glycidoxypropyltriethoxysilane, 2,3-Epoxypropyltrimethoxysilane, 2,3-Epoxypropyltriethoxysilane, Vinyltrimethoxysilane, Vinyltriethoxysilane, Vinyltris(2-methoxyethoxy) silane, Vinyltriacetoxysilane, Vinyltriphenoxysilane, or any combination thereof.

Advantageously the coating layer may have a surface tension of at least 32 dyn/cm, preferably at least 34 dyn/cm, more preferably at least 36 dyn/cm, measured according to ASTM D7490-13 (2022). A disadvantage of a coating layer can be that its surface tension, or surface energy is generally below the surface energy required for installation of the panel using an adhesive. If the surface tension is at least 32 dyn/cm, the adhesion of the panel using an adhesive layer is sufficient. A surface tension above 32 dyn/cm, preferably above 34 dyn/cm, most preferably above 36 dyn/cm is preferred, as it further enhances adherence capabilities of the coating layer.

Preferably, the panel comprises a top layer located on a top surface of the core layer, preferably a decorative top layer. A decorative top layer provides for an aesthetically pleasing panel. Optionally, a second coating layer can be provided on the top surface of the core layer, in between the core layer and the top layer. Such a second coating layer may prevent migration of plasticizers from the core layer to the top layer.

It is conceivable that this second coating layer is designed to receive a decorative print. Therefore, in another exemplary embodiment of the present invention, an at least one digitally printed layer is provided with a digital embossing on the top surface of the core layer of the panel, with a coating layer on the back or bottom surface of the core layer for balancing.

In another embodiment of the present invention, the top surface of the panel and/or the decorative top layer comprises at least partially at least one viscoelastic coating layer and/or a thermoset coating, an at least partially digitally printed layer and/or an excimer cured coating layer. It is further conceivable that said viscoelastic coating layer comprises at least partially a tactile texture and/or an embossing provided thereon by chemical and/or mechanical means. It is also imaginable that at least one embossing layer is substantially viscoelastic.

The decorative top layer may comprise at least one décor layer and/or at least one protective layer. It is conceivable that at least one décor layer is attached to the core layer. It is also conceivable that the décor layer or the decorative layer itself is a print layer, in particular a digital print layer.

Preferably, the decorative top layer comprises a thermoset protective layer or an at least partially UV-cured protective layer. Additionally or alternatively, the crosslinked polymer may be a thermosetting resin. A thermosetting resin can cure, or harden, by undergoing crosslinking reactions to irreversibly form a three-dimensional network. Thermosetting resins are typically liquid prior to curing, and solid after curing. The curing process involves crosslinking, thereby solidifying the resin.

In a preferred embodiment, the decorative top layer comprises at least one décor layer and/or at least one wear layer. The wear layer could for example be scratch resistant layer. The decorative top layer may comprise a wear layer or finishing layer, for example with a thermosetting varnish or lacquer such as polyurethane, PUR, or a melamine-based resin. In a preferred embodiment, the top layer comprises at least one substantially transparent wear layer or finishing layer. The wear layer may comprise one or more transparent layers of a thermoplastic or thermosetting resin.

Non-limiting examples of thermoplastic or thermosetting resins which could be used are polyvinyl chloride (PVC), polystyrene (PS), polyethylene (PE), polyurethane (PU), acrylonitrile butadiene styrene (ABS), polypropylene (PP), Polyethylene terephthalate (PET), phenolic and/or melamine or formaldehyde resins. The wear layer may also be applied in a liquid or paste-like form made of a thermosetting resin such as but not limited to phenolic and/or melamine or formaldehyde resins. The wear layer may comprise or may be substantially composed of an inherently scratch-resistant thermosetting resin impregnating a carrier layer such as paper or lignocellulose. Typically, a preferred thickness of the wear layer lies within the range of 0.1 to 2.0 mm, more preferably between 0.15 mm to 1.0 mm and most preferably between 0.2 mm to 0.8 mm.

In an embodiment, the panel may comprise a decorative print provided by rotogravure printing or digital printing, a wood veneer, at least one ply of cellulose, a ceramic tile, and/or a stone veneer. It is for example possible that the décor layer comprises a plurality of impregnated layers containing lignocellulose but also a wood veneer, a thermoplastic layer, a stone veneer, a veneer layer or the like and/or a combination of said materials.

The veneer layer is preferably selected from the group comprising wood veneer, cork veneer, bamboo veneer, and the like. Other materials such as ceramic tiles or porcelain, a real stone veneer, a rubber veneer, a decorative plastic or vinyl, linoleum, and laminated decorative thermoplastic material in the form of foil or film. The thermoplastic material can be PP, PET, PVC and the like. The at least one thermoplastic may also be selected from Polylactic Acid (PLA), Polyhydroxyalkanoates (PHA), Polybutylene Succinate (PBS), Polyhydroxyurethane (PHU), Cellulose Acetate (CA), Starch-based Bioplastics, Polyethylene Terephthalate (PET), Polyglycolic Acid (PGA), Polyhydroxyalkanoate-Co-Valerate (PHA-V), Polybutylene Adipate Terephthalate (PBAT), and the like.

The decorative layer, décor layer, or decorative print may also form integral part of the core layer. In a beneficial embodiment of the panel, at least part of the upper surface of the core layer is provided with at least one decorative pattern or decorative image. It is for example possible that such decorative image or pattern is provided via printing, for example via digital and/or inkjet printing. It is also possible that at least one decorative pattern is formed by relief provided on the upper surface of the core layer or panel. It is also conceivable that the décor layer or decorative layer is a separate layer, for example a high-pressure laminate (HPL), a veneer layer, a directly laminated paper layer, and/or a ceramic tile.

The design of the decorative layer can be chosen from a design database which includes digitally processed designs, traditional patterns, pictures or image files, customized digital artworks, randomized image patterns, abstract art, wood-patterned images, ceramic or concrete style images, or user-defined patterns. The designs can be printed or reproduced using laser printers, inkjet printers, or any other digital printing means including conventional printing methods. Various types of inks can also be used to suit the design needs of the décor layer. Preferably, the ink used during the printing method comprises properties such as but is not limited to waterproofness, lightfastness, acid-free, metallic, glossy, sheen, shimmering, or deep black, among others.

It is preferred that the decorative layer is visually exposed by the coating layer being a substantially transparent coating layer. The décor layer may comprise a pattern, wherein the pattern is printed via digital printing, inkjet printing, rotogravure printing machine, electronic line shaft (ELS) rotogravure printing machine, automatic plastic printing machine, offset printing, flexography, or rotary printing press. The thickness of the decorative layer is preferably in the range of 0.05 mm to 0.10 mm, for example a thickness of 0.06 mm to 0.08 mm, such as 0.07 mm.

Preferably, the coating layer has a shrinking rate A when tested according to ISO 23999 and wherein the protective layer has a shrinking rate B when tested according to ISO 23999, wherein B<A, most preferably wherein A≈1.1·B. This achieves a balanced construction for the panel with a cupping and bending of the panel of less than 1 mm when tested at 80° C. according to ISO 23999.

In an embodiment, the core layer may comprise 10-40 wt. % of the binder, 20-60 wt. % of the mineral filler, and at least 4 wt. %, preferably at least 6 wt. %, most preferably at least 8 wt. % of the plasticizer, based on total weight of the core layer. A relatively high mineral filler and plasticizer content combine to provide a wear resistant, yet flexible panel. The use of a coating layer is particularly advantageous for these types of panels, due to their relatively high plasticizer content. Not only does the coating layer prevent the dissolving of an adhesive layer used to attach the panel to a surface, but it also prevents the core layer from becoming brittle, due to plasticizer molecules leaving the core layer.

The binder may be selected from polypropylene (PP), polyethylene terephthalate (PET), polyvinyl chloride (PVC), chlorinated polyvinyl chloride (CPVC), chlorinated polyethylene (CPE), Polylactic Acid (PLA), Polyhydroxyalkanoates (PHA), Polybutylene Succinate (PBS), Polyhydroxyurethane (PHU), Cellulose Acetate (CA), Starch-based Bioplastics, Polyglycolic Acid (PGA), Polyhydroxyalkanoate-Co-Valerate (PHA-V), Polybutylene Adipate Terephthalate (PBAT), TPU, LDPE, LLDPE, HDPE, PS, HIPS, GPPS, PA, PETG, PPC, PC, ABS, PVDF, starch-based polymers, PHD, Bio-PE, LA, cellulose acetate, or any combination thereof.

Advantageously, the coating layer may have a thickness in a range of 0.01-0.30 mm, preferably 0.05-0.25 mm, more preferably 0.10-0.20 mm, most preferably 0.13-0.17 mm. A coating layer that is too thin, requires a very high crosslinking density to effectively block migration of plasticizer molecules. This high density reduces the flexibility of the coating layer and increases brittleness of the panel and as such is not desirable in a plasticized panel. It was experimentally found that a thickness in a range of 0.13-0.17 mm provides and optimal trade-off between the coating layer preventing migration of plasticizer molecules, while still being sufficiently flexible.

Preferably, the coating layer is formed by polymerizing and crosslinking at least one oligomer and at least one monomer, in particular, an acrylate oligomer and an acrylate monomer. The acrylate oligomer provides flexibility, adhesion, and abrasion resistance to the coating layer, while the acrylate monomer helps to control the crosslink density and improve the coating layer's mechanical properties. The coating layer also resists plasticizer migration by acting as a barrier that prevents diffusion and limits the mobility of the plasticizer molecules towards an adhesive layer, when the coating layer is present between the core layer and an adhesive layer. The coating layer as such resists plasticizer migration and provides a sealing function to the lower surface of the core layer of the panel. It can therefore be understood to function as a sealing layer and/or plasticizer sealing layer.

The at least one oligomer, and in particular the at least one acrylate oligomer, is selected from urethane acrylate oligomers, polyester-based urethane acrylate oligomers, aliphatic urethane acrylate oligomers, aromatic urethane acrylate oligomers, polyether-based urethane acrylate oligomers, waterborne urethane acrylate oligomers, polyester acrylate oligomers, unsaturated polyester acrylates, polyester acrylates, adhesion-promoting polyester acrylates, low-molecular weight polyester acrylates, water-reducible polyester acrylates, epoxy acrylate oligomers, bisphenol A epoxy acrylates, aliphatic epoxy acrylates, cycloaliphatic epoxy acrylates, low-viscosity epoxy acrylates, novolac epoxy acrylates, silicone acrylate oligomers, hydrophilic silicone acrylates, silicone acrylates, silicone-modified acrylates, low-viscosity silicone acrylates, and silicone-modified urethane acrylate.

In line with the above, the at least one monomer, and in particular the at least one acrylate monomer, may be selected from tetrahydrofurfuryl acrylate, pentaerythritol triacrylate, 2-hydroxyethyl acrylate (HEA), ethoxylated bisphenol A diacrylate (EBDA), trimethylolpropane triacrylate (TMPTA), isobornyl acrylate (IBOA), and cyclohexyl acrylate (CHA).

Preferably, the coating layer comprises a core-facing layer adjacent to the core layer and an opposite outward facing layer, wherein: the core-facing layer comprises at least partially reactive carboxylic and/or amine functional groups, the core-facing layer is substantially inert to the plasticizer, the outward facing layer comprises at least one organosilane, and/or the outward facing layer has a surface energy of at least 32 dyn/cm, preferably at least 34 dyn/cm, more preferably at least 36 dyn/cm, measured according to ASTM D7490-13 (2022).

In a second aspect, the invention relates to a composition for forming a coating layer, comprising:
30-50 wt. % of at least one acrylate oligomer,
10-20 wt. % of at least one acrylate monomer, and
1-5 wt. % of at least one photoinitiator.

A coating layer as described hereinabove can be formed with this composition. The photoinitiator is preferably capable of initiating the ultraviolet (UV) curing process of the composition. Advantageously, the composition may be a liquid composition, such that it can easily be applied to a core of a panel prior to curing. This composition can be applied to a panel, and the resulting coating layer has all the benefits as described hereinabove.

Preferably, the at least one acrylate oligomer is selected from urethane acrylate oligomers, polyester-based urethane acrylate oligomers, aliphatic urethane acrylate oligomers, aromatic urethane acrylate oligomers, polyether-based urethane acrylate oligomers, waterborne urethane acrylate oligomers, polyester acrylate oligomers, unsaturated polyester acrylates, polyester acrylates, adhesion-promoting polyester acrylates, low-molecular weight polyester acrylates, water-reducible polyester acrylates, epoxy acrylate oligomers, bisphenol A epoxy acrylates, aliphatic epoxy acrylates, cycloaliphatic epoxy acrylates, low-viscosity epoxy acrylates, novolac epoxy acrylates, silicone acrylate oligomers, hydrophilic silicone acrylates, silicone acrylates, silicone-modified acrylates, low-viscosity silicone acrylates, silicone-modified urethane acrylate, or any combination thereof.

The at least one acrylate monomer may be selected from tetrahydrofurfuryl acrylate, pentaerythritol triacrylate, 2-hydroxyethyl acrylate (HEA), ethoxylated bisphenol A diacrylate (EBDA), trimethylolpropane triacrylate (TMPTA), isobornyl acrylate (IBOA), cyclohexyl acrylate (CHA), or any combination thereof.

The at least one photoinitiator may be selected from alpha-hydroxy ketones, 2-hydroxy-2-methyl-1-phenylpropan-1-one (HMPP), 1-hydroxycyclohexyl phenyl ketone (HCPK), benzophenones, benzophenone (BP), 4,4′-bis(dimethylamino) benzophenone, phosphine oxides, bis(2,4,6-trimethylbenzoyl)-phenylphosphineoxide (TPO), 2-methyl-1-[4-(methylthio)phenyl]-2-morpholinopropan-1-one, acylphosphine oxides, 2,4,6-trimethylbenzoyl-diphenylphosphineoxide (TPO-L), 2,4,6-trimethylbenzoylphenylphosphineoxide (TPO-P), iodonium salts, diphenyliodonium hexafluorophosphate (DPI-HFP), and (4-methylphenyl)-phenyliodonium hexafluoroantimonate (MPI-HFA), or any combination thereof.

The composition may comprise at least one organosilane. In particular a weight percentage of the at least one organosilane ranges between 0.5 and 5 wt %, based on total weight of the composition. This provides the advantages as disclosed hereinabove.

In line with the above, the at least one organosilane may be selected from aminosilanes, methacryloyx silanes, epoxy silanes, vinyl silanes, 3-Aminopropyltriethoxysilane, N-(2-Aminoethyl)-3-aminopropyltrimethoxysilane, N-(2-Aminoethyl)-3-aminopropylmethyldimethoxysilane, N-(2-Aminoethyl)-3-aminopropyltriethoxysilane, N-(6-Aminohexyl)aminopropyltrimethoxysilane, 3-Methacryloxypropyltrimethoxysilane, 3-Methacryloxypropyltriethoxysilane, 3-Methacryloxypropylmethyldimethoxysilane, 3-Methacryloxypropylmethyldiethoxysilane, 3-Methacryloxypropylphenyldimethylsiloxane, 3-Glycidoxypropyltrimethoxysilane, 3-Glycidoxypropylmethyldiethoxysilane, 3-Glycidoxypropyltriethoxysilane, 2,3-Epoxypropyltrimethoxysilane, 2,3-Epoxypropyltriethoxysilane, Vinyltrimethoxysilane, Vinyltriethoxysilane, Vinyltris(2-methoxyethoxy) silane, Vinyltriacetoxysilane, Vinyltriphenoxysilane, or any combination thereof.

In a third aspect, the present invention relates to a method of manufacturing a panel as disclosed hereinabove, comprising:
providing a core layer comprising at least one mineral filler and at least one polymeric binder,
optionally, providing a decorative top layer to at least part of a top surface of the core layer,
applying a composition as disclosed hereinabove to at least part of a bottom surface of the core layer, and
at least partially crosslinking the composition to obtain a coating layer.

The core layer can be provided by mixing a mineral filler, a thermoplastic, a plasticizer and optionally additives together to form a thermoplastic melt. By extruding the thermoplastic melt, a core layer can be obtained. The core layer may comprise at least one plasticizer, as disclosed hereinabove for the panel.

Preferably a mass of the composition is applied to an area of the at least part of the bottom surface of the core layer in a range between 10 and 90 g/m². Advantageously, the composition may be applied in an uncured state. This mass of the composition per unit area allows the coating layer, created by curing the composition, to effectively prevent migration of plasticizer molecules through the coating layer.

Preferably curing the composition comprises curing the composition with UV light, at least one excimer, pressure, infrared light, electron beam curing (EBC), temperature, or any combination thereof. Curing by UV light is an effective method of curing that can simply be affected with UV light. UV light has a wavelength shorter than visible light, but longer than X-rays. UV light has a wavelength typically ranging between 100 and 400 nm.

The panel according to the invention may further comprise at least one top layer, preferably a decorative top layer. Such decorative top layer may for example be a high-pressure laminate (HPL), a plurality of impregnated layers containing lignocellulose, a wood veneer, a thermoplastic layer containing at least a decorative layer and optionally a protective top layer, a stone veneer or the like, and/or a combination of said decorative layers. The decorative top layer may possibly also comprise at least one ply of cellulose-based layer and a cured resin, wherein the cellulose-based layer is preferably paper or kraft paper. Said ply of cellulose-based material may also be a veneer layer adhered to a top surface of the core layer. The veneer layer is preferably selected from the group consisting of wood veneer, cork veneer, bamboo veneer, and the like. Other decorative top layers that can be considered according to the invention include ceramic tiles or porcelain, a real stone veneer, a rubber veneer, a decorative plastic or vinyl, linoleum, and decorative thermoplastic film or foil which may be laminated with a wear layer and optionally a coating. Examples of thermoplastics may be PP, PET, PVC and the like. It is also possible to provide on the top facing surface of the core an optional primer and print the desired visual effect in a direct printing process. The decorative layer can receive a further finishing with a thermosetting varnish or lacquer such as polyurethane, PUR, or a melamine-based resin. The panel, and in particular the top layer could optionally comprise at least one gloss control layer. The panel, and in particular the top layer, could also comprise at least one, and preferably a plurality of acrylic coating layers.

It is further conceivable that the coating layer is provided on the bottom surface of core layer of the panel, wherein the coating layer is a viscoelastic coating layer, and/or thermoset coating layer, and/or an excimer cured coating layer.

It is conceivable that the wear resistant particles are scattered, at least partially enclosed or embedded, preferably completely enclosed or embedded, by an at least one coating layer. It is likewise conceivable that the wear resistant particles are scattered, at least partially enclosed or embedded, preferably completely enclosed and embedded by at least one coating and/or wear layer, such that the wear resistant particles are encapsulated by the at least one coating, and/or are encapsulated by the at least one wear layer, preferably by at least two wear layers, and/or by the at least one top layer.

It is likewise conceivable that the wear resistant particles are chosen from the group of aluminium oxide, corundum, silicon carbide, titanium dioxide, titanium oxide and/or diamond particles or diamond dust.

In a further embodiment, the at least one coating layer may further comprise antimicrobial, antiviral, antibacterial and/or antifungal agents.

In a preferred embodiment the panel comprises at least one acoustic backing adhered to the back side of the core layer. The backing layer may also be referred to as a cushioning or damping layer. Backing layers are typically made of polymeric materials such as, but not limited to, ethylene vinyl acetate (EVA), radiation cross-linked polyethylene (IXPE), expanded polypropylene (XPP), and/or expanded polystyrene (XPS) of low-density foam layer. However, it is also conceivable that the backing layer comprises non-woven fibers, such as natural fibers like hemp or cork, and/or recycled/recyclable materials, such as PET, felt, recycled carpet, and the like.

### CLAUSES

The invention will be elucidated based on the following non-limitative clauses.
1. Panel, in particular a floor panel or wall panel, comprising:
   at least one core layer comprising at least one mineral filler, at least one polymeric binder, and at least one plasticizer; and at least one coating layer located on a bottom surface of the at least one core layer;
   wherein the at least one coating layer comprises an at least partly crosslinked polymer impermeable to at least one plasticizer.
2. Panel according to clause 1, wherein the at least partially crosslinked polymer comprises a crosslinked polymeric network.
3. Panel according to clause 1 or clause 2, wherein the at least partially crosslinked polymer has a crosslinking density of at least 50%, more preferably at least 60%, most preferably at least 65%.
4. Panel according to clause 2 or clause 3, wherein the crosslinked polymeric network comprises a plurality of voids, and
   wherein an average void diameter is smaller or equal to a diameter of gyration of the at least one plasticizer.
5. Panel according to any one of claims 1-4, wherein a plasticizer migration rate of the at least one plasticizer through the at least one coating layer, measured according to ISO 177:2016 is less than 0.01 mg/cm².
6. Panel according to any one of clauses 1-5, wherein the at least one coating layer is substantially impervious to the at least one plasticizer.
7. Panel according to any of clauses 1-6, wherein a weight ratio of the at least one mineral filler to the at least one polymeric binder is at least 3.5:1, preferably at least 4.0:1, and most preferably at least 4.5:1.
8. Panel according to any one of clauses 1-7, wherein the at least one binder comprises a thermoplastic elastomer, a polymer having a glass transition temperature below 0° C., measured according to ISO 6721-11:2019, a biopolymer, synthetic resin, or any combination thereof.
9. Panel according to any one of clauses 1-8, wherein a weight percentage of the at least one plasticizer is at least 4 wt. %, preferably at least 6 wt %, more preferably at least 8 wt. %, based on total weight of the at least one core layer.
10. Panel according to any one of clauses 1-9, wherein the at least partially crosslinked polymer comprises at least one carboxyl functional group and/or at least one amine functional group capable of reacting with the at least one plasticizer.
11. Panel according to any one of clauses 1-10, wherein the at least partially crosslinked polymer is inert to the at least one plasticizer.
12. Panel according to any one of clauses 1-11, wherein the at least one plasticizer is an external plasticizer.
13. Panel according to any one of clauses 1-12, wherein the at least one plasticizer is selected from diisononyl phthalate (DINP), diisodecyl phthalate (DIDP), diethylhexyl phthalate (DEHP), dibutyl phthalate (DBP), butyl benzyl phthalate (BBP), di(2-ethylhexyl) adipate (DEHA), di(2-ethylhexyl) sebacate (DOS), di(2-ethylhexyl) terephthalate (DOTP), diisononyl cyclohexane-1,2-dicarboxylate (DINCH), triethyl citrate (TEC), di(2-ethylhexyl) phthalate (DEHP), di-n-octyl phthalate (DNOP), diisobutyl phthalate (DIBP), di-n-hexyl phthalate (DNHP), diethyl phthalate (DEP), dicyclohexyl phthalate (DCHP), diethylene glycol dibenzoate (DEDB), epoxidized soybean oil (ESBO), citrates, citrate esters, castor oil derivatives, epoxidized vegetable oils, succinic acid esters, tartaric acid, sorbitol, polyethylene glycol, starch, epoxidized soybean oil (ESBO), tributyl citrate (TBC), acetyl tributyl citrate (ATBC), triethyl citrate A (TEC-A), triclocarban (TCC), bis(2-ethylhexyl) maleate, bis(2-ethylhexyl) fumarate, DOML (linseed oil), DOP (castor oil based), DEHT (castor oil), GEFA, ELO, ESO, EVO, ELOV, ELOVAT, DOSA, DOA, DIDA, DES, DBS, PEG, Lactic Acid, Oleic acid, PPG, PES, Paraffinic oils, naphthenic oils, esters, or any combination thereof.
14. Panel according to any one of clauses 1-13, wherein the at least one coating layer comprises at least one coupling agent.
15. Panel according to clause 14, wherein the at least one coupling agent comprises at least one organosilane.
16. Panel according to clause 14 or clause 15, wherein a weight percentage of the at least one coupling agent is in the range of 0.5-5.0 wt. %, preferably 1.0-4.0 wt. %, more preferably 2.0-3.0 wt. %, most preferably 2.3-2.7 wt. %, based on total weight of the at least one coating layer.
17. Panel according to any one of clauses 14-16, wherein the at least one coupling agent is selected from aminosilanes, methacryloyx silanes, epoxy silanes, vinyl silanes, 3-Aminopropyltriethoxysilane, N-(2-Aminoethyl)-3-aminopropyltrimethoxysilane, N-(2-Aminoethyl)-3-aminopropylmethyldimethoxysilane, N-(2-Aminoethyl)-3-aminopropyltriethoxysilane, N-(6-Aminohexyl)aminopropyltrimethoxysilane, 3-Methacryloxypropyltrimethoxysilane, 3-Methacryloxypropyltriethoxysilane, 3-Methacryloxypropylmethyldimethoxysilane, 3-Methacryloxypropylmethyldiethoxysilane, 3-Methacryloxypropylphenyldimethylsiloxane, 3-Glycidoxypropyltrimethoxysilane, 3-Glycidoxypropylmethyldiethoxysilane, 3-Glycidoxypropyltriethoxysilane, 2,3-Epoxypropyltrimethoxysilane, 2,3-Epoxypropyltriethoxysilane, Vinyltrimethoxysilane, Vinyltriethoxysilane, Vinyltris(2-methoxyethoxy) silane, Vinyltriacetoxysilane, Vinyltriphenoxysilane, or any combination thereof.
18. Panel according to any one of clauses 1-17, wherein the at least one coating layer has a surface tension of at least 32 dyn/cm, preferably at least 34 dyn/cm, more preferably at least 36 dyn/cm, measured according to ASTM D7490-13 (2022).
19. Panel according to any one of clauses 1-18, comprising a decorative top layer located on a top surface of the at least one core layer.
20. Panel according to clause 19, wherein the decorative top layer comprises a thermoset protective layer or an at least partially UV-cured protective layer.
21. Panel according to clause 19 or clause 20, comprising a decorative print provided by rotogravure printing or digital printing, a wood veneer, at least one ply of cellulose, a ceramic tile, and/or a stone veneer.
22. Panel according to clause 20 or clause 21, wherein the at least one coating layer has a shrinking rate A when tested according to ISO 23999 and wherein the protective layer and/or decorative top layer has a shrinking rate B when tested according to ISO 23999, wherein B<A, most preferably wherein A≈1.1·B.
   23. Panel according to any one of clauses 1-22, wherein the at least one core layer comprises 10-40 wt. % of the binder, 20-60 wt. % of the at least one mineral filler, and at least 4 wt. %, preferably at least 6 wt. %, most preferably at least 8 wt. % of the at least one plasticizer, based on total weight of the at least one core layer.
24. Panel according to any one of clauses 1-23, wherein the at least one binder is selected from polypropylene (PP), polyethylene terephthalate (PET), polyvinyl chloride (PVC), chlorinated polyvinyl chloride (CPVC), chlorinated polyethylene (CPE), Polylactic Acid (PLA), Polyhydroxyalkanoates (PHA), Polybutylene Succinate (PBS), Polyhydroxyurethane (PHU), Cellulose Acetate (CA), Starch-based Bioplastics, Polyglycolic Acid (PGA), Polyhydroxyalkanoate-Co-Valerate (PHA-V), Polybutylene Adipate Terephthalate (PBAT), TPU, LDPE, LLDPE, HDPE, PS, HIPS, GPPS, PA, PETG, PPC, PC, ABS, PVDF, starch-based polymers, PHD, Bio-PE, LA, cellulose acetate, or any combination thereof.
25. Panel according to any one of clauses 1-24, wherein the at least one coating layer has a thickness in a range of 0.01-0.30 mm, preferably 0.05-0.25 mm, more preferably 0.10-0.20 mm, most preferably 0.13-0.17 mm.
26. Panel according to any one of clauses 1-25, wherein the at least one coating layer is formed by polymerizing and crosslinking at least one oligomer and at least one monomer, in particular an acrylate oligomer and an acrylate monomer.
27. Panel according to clause 26, wherein the at least one oligomer is selected from urethane acrylate oligomers, polyester-based urethane acrylate oligomers, aliphatic urethane acrylate oligomers, aromatic urethane acrylate oligomers, polyether-based urethane acrylate oligomers, waterborne urethane acrylate oligomers, polyester acrylate oligomers, unsaturated polyester acrylates, polyester acrylates, adhesion-promoting polyester acrylates, low-molecular weight polyester acrylates, water-reducible polyester acrylates, epoxy acrylate oligomers, bisphenol A epoxy acrylates, aliphatic epoxy acrylates, cycloaliphatic epoxy acrylates, low-viscosity epoxy acrylates, novolac epoxy acrylates, silicone acrylate oligomers, hydrophilic silicone acrylates, silicone acrylates, silicone-modified acrylates, low-viscosity silicone acrylates, and silicone-modified urethane acrylate.
28. Panel according to clause 26 or clause 27, wherein the at least one monomer is selected from tetrahydrofurfuryl acrylate, pentaerythritol triacrylate, 2-hydroxyethyl acrylate (HEA), ethoxylated bisphenol A diacrylate (EBDA), trimethylolpropane triacrylate (TMPTA), isobornyl acrylate (IBOA), and cyclohexyl acrylate (CHA).
29. Panel according to any one of clauses 1-28, wherein the at least one coating layer comprises a core-facing layer adjacent to the core layer and an opposite outward facing layer, wherein:
   the core-facing layer comprises at least partially reactive carboxylic and/or amine functional groups,
   the core-facing layer is substantially inert to the plasticizer,
   the outward facing layer comprises at least one organosilane, and/or
   the outward facing layer has a surface energy of at least 32 dyn/cm, preferably at least 34 dyn/cm, more preferably at least 36 dyn/cm, measured according to ASTM D7490-13 (2022).
30. A composition for forming at least one coating layer, comprising:
   30-50 wt. % of at least one acrylate oligomer,
   10-20 wt. % of at least one acrylate monomer, and
   1-5 wt. % of at least one photoinitiator.
31. The composition according to clause 30, wherein the at least one acrylate oligomer is selected from urethane acrylate oligomers, polyester-based urethane acrylate oligomers, aliphatic urethane acrylate oligomers, aromatic urethane acrylate oligomers, polyether-based urethane acrylate oligomers, waterborne urethane acrylate oligomers, polyester acrylate oligomers, unsaturated polyester acrylates, polyester acrylates, adhesion-promoting polyester acrylates, low-molecular weight polyester acrylates, water-reducible polyester acrylates, epoxy acrylate oligomers, bisphenol A epoxy acrylates, aliphatic epoxy acrylates, cycloaliphatic epoxy acrylates, low-viscosity epoxy acrylates, novolac epoxy acrylates, silicone acrylate oligomers, hydrophilic silicone acrylates, silicone acrylates, silicone-modified acrylates, low-viscosity silicone acrylates, silicone-modified urethane acrylate, or any combination thereof.
32. The composition according to clause 30 or clause 31, wherein the at least one acrylate monomer is selected from tetrahydrofurfuryl acrylate, pentaerythritol triacrylate, 2-hydroxyethyl acrylate (HEA), ethoxylated bisphenol A diacrylate (EBDA), trimethylolpropane triacrylate (TMPTA), isobornyl acrylate (IBOA), cyclohexyl acrylate (CHA), or any combination thereof.
33. The composition according to any one of clauses 30-32, wherein the at least one photoinitiator is selected from alpha-hydroxy ketones, 2-hydroxy-2-methyl-1-phenylpropan-1-one (HMPP), 1-hydroxycyclohexyl phenyl ketone (HCPK), benzophenones, benzophenone (BP), 4,4′-bis(dimethylamino) benzophenone, phosphine oxides, bis(2,4,6-trimethylbenzoyl)-phenylphosphineoxide (TPO), 2-methyl-1-[4-(methylthio)phenyl]-2-morpholinopropan-1-one, acylphosphine oxides, 2,4,6-trimethylbenzoyl-diphenylphosphineoxide (TPO-L), 2,4,6-trimethylbenzoylphenylphosphineoxide (TPO-P), iodonium salts, diphenyliodonium hexafluorophosphate (DPI-HFP), and (4-methylphenyl)-phenyliodonium hexafluoroantimonate (MPI-HFA), or any combination thereof.
34. The composition according to any one of clauses 30-33, comprising at least one organosilane.
35. The composition according to clause 34, wherein a weight percentage of the at least one organosilane ranges between 0.5 and 5 wt %, based on total weight of the composition.
36. The composition according to clause 34 or clause 35, wherein the at least one organosilane is selected from aminosilanes, methacryloyx silanes, epoxy silanes, vinyl silanes, 3-Aminopropyltriethoxysilane, N-(2-Aminoethyl)-3-aminopropyltrimethoxysilane, N-(2-Aminoethyl)-3-aminopropylmethyldimethoxysilane, N-(2-Aminoethyl)-3-aminopropyltriethoxysilane, N-(6-Aminohexyl)aminopropyltrimethoxysilane, 3-Methacryloxypropyltrimethoxysilane, 3-Methacryloxypropyltriethoxysilane, 3-Methacryloxypropylmethyldimethoxysilane, 3-Methacryloxypropylmethyldiethoxysilane, 3-Methacryloxypropylphenyldimethylsiloxane, 3-Glycidoxypropyltrimethoxysilane, 3-Glycidoxypropylmethyldiethoxysilane, 3-Glycidoxypropyltriethoxysilane, 2,3-Epoxypropyltrimethoxysilane, 2,3-Epoxypropyltriethoxysilane, Vinyltrimethoxysilane, Vinyltriethoxysilane, Vinyltris(2-methoxyethoxy) silane, Vinyltriacetoxysilane, Vinyltriphenoxysilane, or any combination thereof.
37. Method of manufacturing a panel according to any one of clauses 1-29, comprising:
   providing a core layer comprising at least one mineral filler and at least one polymeric binder,
   optionally, providing a decorative top layer to at least part of a top surface of the core layer,
   applying a composition according to any one of claims 30-36 to at least part of a bottom surface of the core layer, and
   at least partially crosslinking the composition to obtain an at least partially crosslinked coating layer.
38. Method according to clause 37, wherein the core layer comprises at least one plasticizer.
39. Method according to clause 37 or clause 38, wherein a mass of the composition is applied to an area of the at least part of the bottom surface of the core layer in a range between 10 and 90 g/m².
40. Method according to any one of clauses 37-39, wherein the method of curing the composition is chosen from the group of UV light, at least one excimer, pressure, infrared light, electron beam curing (EBC), temperature, or any combination thereof.

### BRIEF DESCRIPTION OF THE FIGURES

The invention will now be elucidated on the basis of non-limitative exemplary embodiments shown in the following figures. Herein shows:

FIG. 1 a perspective view of a prior art panel comprising plasticizer molecules;

FIG. 2 a cross sectional view of a panel according to the present invention;

FIG. 3 a cross sectional view of another panel according to the present invention;

FIG. 4 a cross sectional view of another panel according to the present invention;

FIG. 5 a cross sectional view of another panel with an acoustic backing according to the present invention;

FIG. 6 a cross sectional view of another panel according to the present invention including embossing on the top protective layer and multiple layers of the coating layer;

FIG. 7 a cross sectional view of another panel according to the present invention including an embossing layer;

FIG. 8 a cross sectional view of another panel according to the present invention including a pre-attached acoustic backing;

FIG. 9 a cross sectional view of a wall panel according to the present invention:

FIG. 10 an illustration of the crosslinking in the coating layer;

FIGS. 11a, 11b and 11c an illustration of the crosslinking in the coating layer at varying densities, i.e., 50%, 60%, and 70% and a reference thereof in FIG. 11d;

FIG. 12a an illustration of the relationship of the crosslinking density with void diameter and a reference illustration in FIG. 12b;

FIG. 13 an illustration of an alternative embodiment of a top layer according to the present invention;

FIG. 14 an illustration of an alternative embodiment of a top layer with a digitally printed layer according to the present invention;

FIG. 15 an illustration of an alternative embodiment of a top layer further comprising an embossing according to the present invention;

FIG. 16 an illustration of an alternative embodiment of a top layer without a wear layer according to the present invention;

FIG. 17 an illustration of an alternative embodiment of a top layer further comprising a gloss control layer according to the present invention;

FIG. 18 an illustration of an alternative embodiment of a top layer further comprising at least one acrylic layer according to the present invention;

FIG. 19 an illustration of an alternative embodiment of a top layer wherein embossing is applied up to at least part of the at least one acrylic layer according to the present invention;

FIG. 20 an illustration of an alternative embodiment of a top layer further comprising a gloss control layer wherein embossing is applied up to at least part of the at least one acrylic layer according to the present invention;

FIG. 21 an illustration of another aspect of the present invention;

FIG. 22 an illustration of another aspect of the present invention; and

FIG. 23 an illustration of another aspect of the present invention.

Within these figures, the same reference number refer to similar or equivalent technical features.

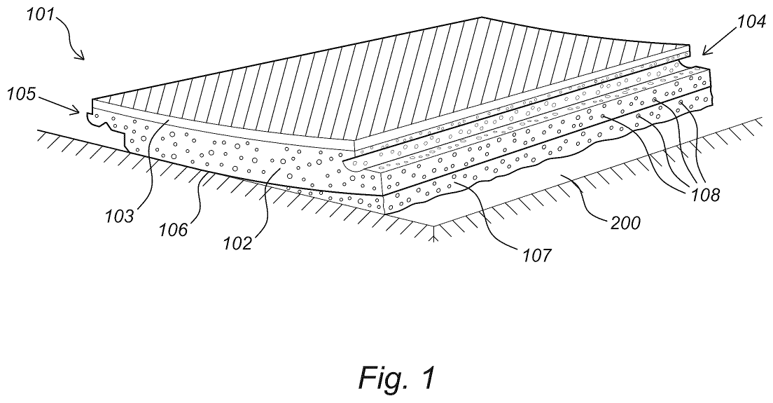

FIG. 1 shows a perspective view of a prior art panel 101 installed on a substrate 200. The panel 101 comprises a core layer 102 and a top coating layer 103. Due to curing of the top coating layer 103 during manufacturing of the panel 101, the panel 101 is curved or cupping. The side edges of the panel comprising the complementary coupling means 104, 105, are located at a relatively large distance from the substrate 200, as compared to the distance of the centre 106 of the panel 101 from the substrate 200.

The panel 101 is adhered to the substrate 200 via an adhesive layer 107. Plasticizer molecules 108 have migrated from the core layer 102 of the panel 101 into the adhesive layer 107. The adhesive layer 107 has liquified as a result.

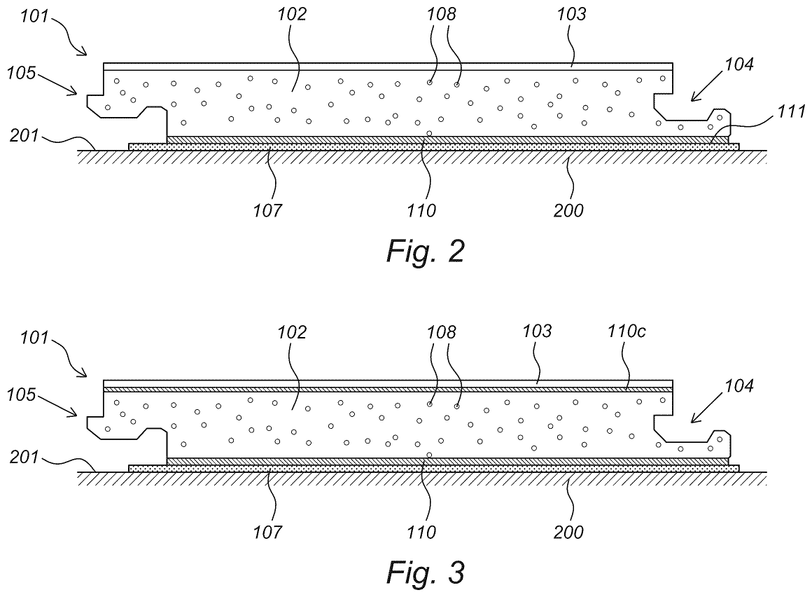

FIG. 2 shows a cross section of a panel 101 according to the present invention, wherein the panel 101 is installed on a substrate 200, for example a floor surface. The panel 101 comprises complementary coupling means 104, 105. The panel comprises a coating layer 110 on the bottom side of the core layer 102. Plasticizer molecules 108 are distributed over the core layer 102. Due to the coating layer 110 being cured, it has shrunk during manufacturing of the panel. As such, the coating layer 110 has balanced the panel 101, resulting in the panel 101 being straight. The adhesive layer 107 has a uniform thickness due to the alignment of the lower bottom surface 111 of the coating layer 110 and the substrate 200. Due to the uniform thickness of the adhesive layer, adherence between the panel 101 and the substrate 200 is improved.

Curing of the coating layer 110 during manufacturing of the panel 101 has not only shrunk the coating layer 110 but has also crosslinked the oligomers and monomers within the coating to form a polymeric network. The polymeric network contains voids having a relatively small diameter, that prevent the plasticizer molecules 108 from migrating through the coating layer 110 into the adhesive layer 107. As a result, the adhesive layer 107 does not liquefy.

Referring now to FIG. 3, a panel 101 installed on a substrate 200 is shown. The panel 101 comprises complementary coupling means 104, 105. This panel 101 differs from the panel in FIG. 2 as it comprises an additional coating layer 110c located in between the top layer 103 and the core layer 102 comprising plasticizer molecules 108. The top layer 103 of the panel 101 of FIG. 3 is a decorative top layer, comprising a printed pattern. The coating layer 110c directly underneath the top layer 103 prevents plasticizer molecules 108 from migrating out of the core layer 102 into the printed pattern. In this way, the coating layer 110c directly underneath the top layer 103 prevents dissolving of the ink in the printed pattern. As such, the printed pattern is maintained for a long period of time. Further, the coating layer 110 provided between the core layer 102 and adhesive layer 107 allows for enhanced adhesion and compatibility with adhesives due to the presence of organosilanes, and improvement in balancing when subjected to temperature fluctuations.

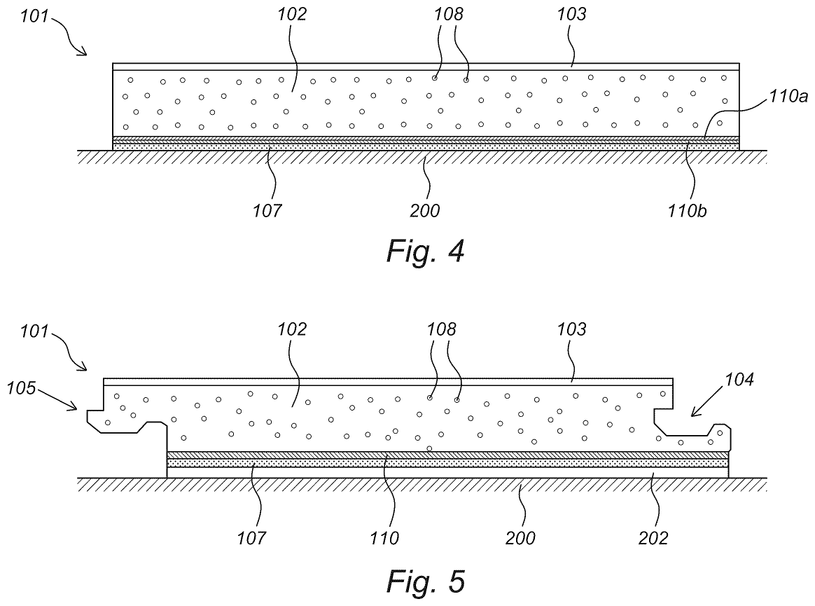

FIG. 4 shows an embodiment of the panel 101 of the present invention, wherein the panel 101 is installed on a substrate 200 and comprises a top layer 103 comprising at least one visual design and at least one protective layer, the top layer 103 having a first shrinking rate, at least one coating layer 110a comprising at least one carboxyl functional group able to react with the at least one plasticizer and at least one coating layer 110b comprising at least one organosilane, allowing a strong bond with the adhesive layer 107, where coating layers 110a and 110b have a second shrinking rate being larger than the top layer's 103 first shrinking rate, preferably being around 10% larger than the top layer's first shrinking rate, thereby balancing the construction. The panel 101 has as a result a cupping rate of less than 1 mm, preferably less than 0.5 mm, when tested to ISO 23999. The panel 101 of the shown embodiment is free of coupling means.

As further exemplified in the panel 101 installed on a substrate 200 as shown in FIG. 5, a top layer 103 is arranged on the top surface of the core layer 102 comprising plasticizer molecules 108. This panel 101 comprises an acoustic backing 202 attached to the back side of the coating layer 110, which is adhered to the core layer 102 by means of an adhesive layer 107. The panel 101 comprises complementary coupling means 104, 105.

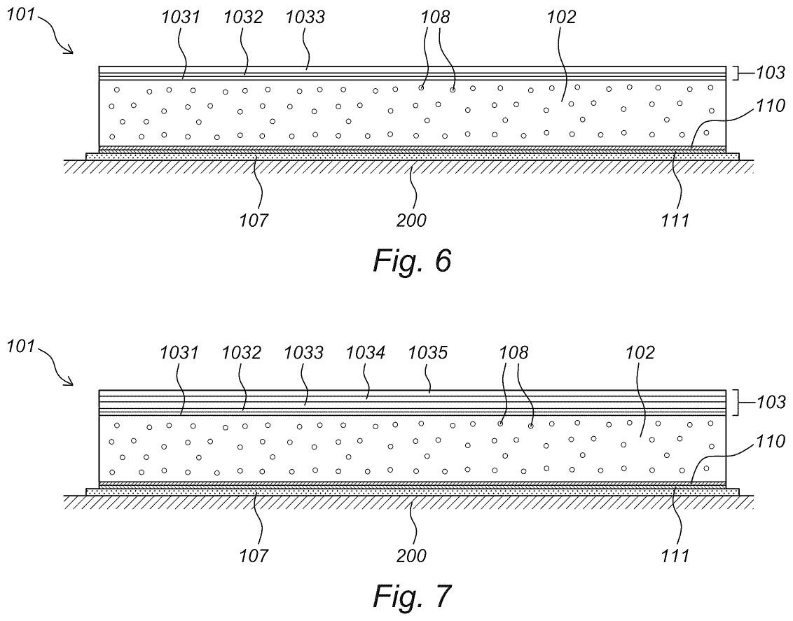

As shown in the panel 101 of FIG. 6, the top layer 103 is a top protective layer 103 comprising a top sealing layer 1031, a decorative print layer 1032, and a top protective layer with embossing 1033. The panel 101 as shown in FIG. 6 comprises multiple coating layers 110, 111 are included in the panel 101, such that a first bottom surface coating layer 110 and a second bottom surface coating layer 111 represent multiple coating layers provided onto the bottom surface of the core layer 102. The panel 101 is installed on a substrate 200 and the core layer 102 comprises plasticizer molecules 108.

The panel 101 as shown in FIG. 7 has a tactile embossing or texture layer 1034. This mechanically or chemically applied texture layer 1034 is present between a top coating layer 1035 and at least one protective layer 1033. The entirety of the top layer 103 construction, including the top sealing layer 1031, decorative print layer 1032, protective layer 1033, embossing layer 1034 and top coating layer 1035 combined having a first shrinking rate; and the entirety of the at least one bottom coating 110, 111 or sealing layer buildup having a second shrinking rate, such as the first coating layer 110 and second coating layer 111, with the second shrinking rate being larger than the top layer 103 construction's first shrinking rate, preferably being around 10% larger than the top layer's first shrinking rate, thereby balancing the construction. The panel 101 has as a result a cupping rate of less than 1 mm, preferably less than 0.5 mm, when tested to ISO 23999. It is conceivable that the at least one coating layer 110 comprises at least one carboxyl functional group able to react with the at least one plasticizer and/or has an average crosslink void diameter which is smaller than the average plasticizer diameter, and/or that the at least one second coating layer 111 comprises at least one organosilane, allowing a strong bond with the adhesive layer 107. The panel 101 as shown is installed on a substrate 200 and the core layer 102 comprises plasticizer molecules 108.

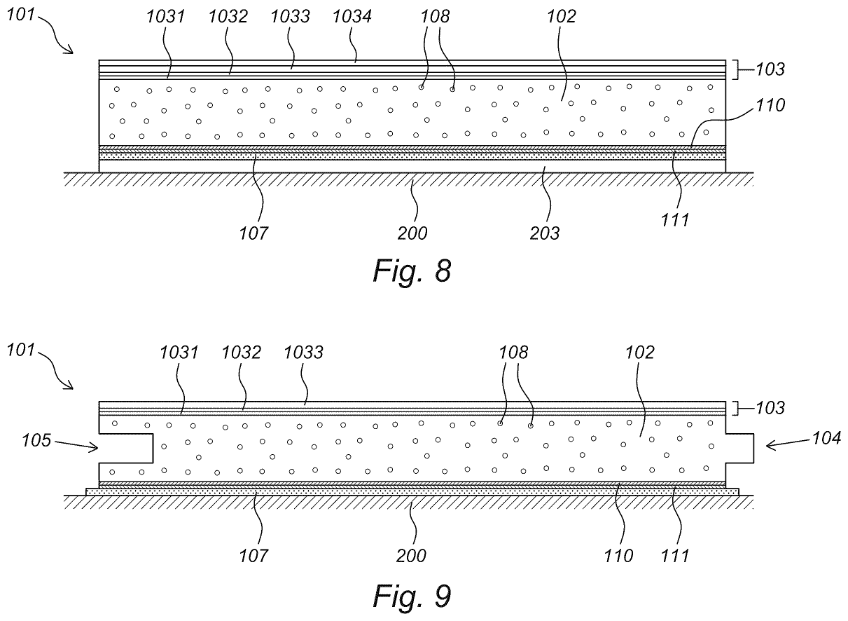

The panel 101 in FIG. 8 comprises a pre-attached acoustic backing 203 which is adhered to the panel 101 by means of an adhesive layer 107. The adhesive's integrity as well as the panel's stability and flatness are ensured by presence of a first bottom surface coating layer 110 and a second bottom surface coating layer 111. The panel 101 as shown is installed on a substrate 200 and the core layer 102 comprises plasticizer molecules 108. The top layer 103 comprises a top sealing layer 1031, a decorative print layer 1032, a protective layer 1033 and an embossing layer 1034.

FIG. 9 shows another exemplary embodiment of a panel 101 according to the present invention such that panel 101 is constructed as a wall panel and is attached to the wall substrate 200. Tongue and groove coupling means 104 and 105 are provided herein for a locking mechanism of the wall panel 101. The core layer 102 comprises plasticizer molecules 108 dispersed over the core layer 102. The panel 101 as shown comprises multiple coating layers 110, 111 are included in the panel 101, such that a first bottom surface coating layer 110 and a second bottom surface coating layer 111 represent multiple coating layers provided onto the bottom surface of the core layer 102. The top layer 103 comprises a top sealing layer 1031, a decorative print layer 1032 and a protective layer 1033.

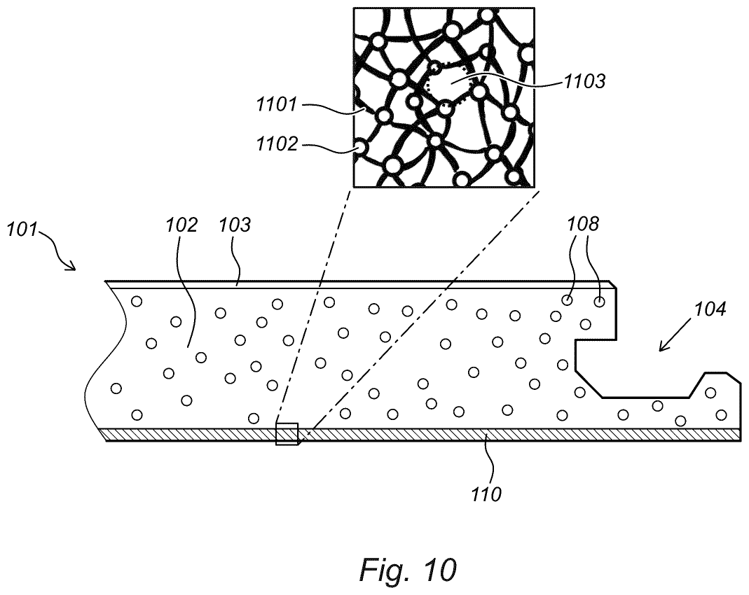

FIG. 10 shows a part of a panel 101, wherein a part of the coating 110 (depicted by a square) is enlarged and schematically shown. The enlarged square in FIG. 10 shows the three-dimensional network, defined by the polymeric backbone 1101 and crosslinks 1102. FIG. 10 further shows the crosslinked properties of the polymer coat or the coating layer 110. The void diameter, Vdia, 1103 (the diameter of the dotted circle) is the measure of the average size of gaps/spaces within the three-dimensional network of the crosslinked polymer. The panel 101 further comprises a core layer 102 comprising plasticizer molecules 108 and a decorative top layer 103. The panel could optionally be provided with coupling means 104.

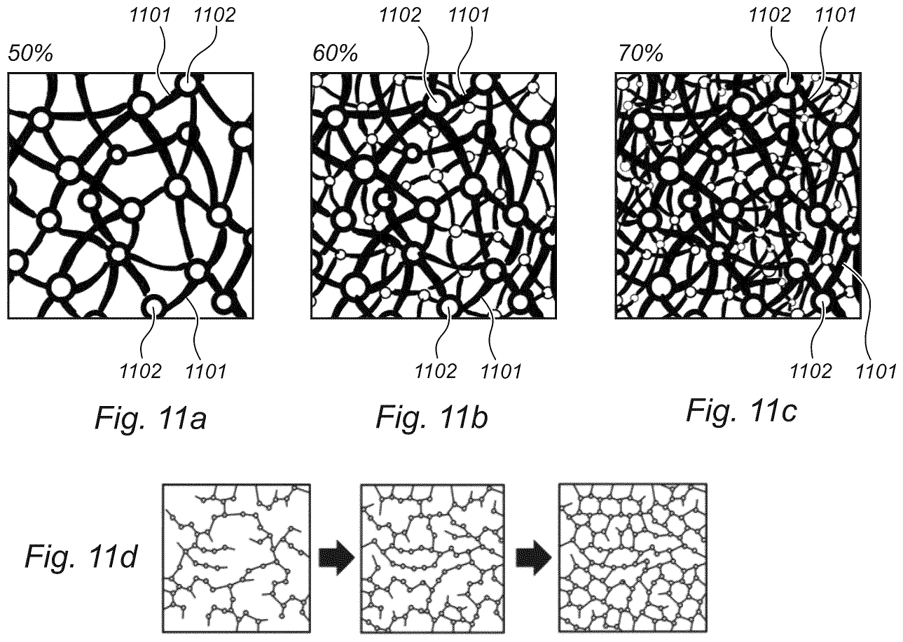

FIGS. 11a, 11b and 11c show schematic representations of the three-dimensional networks defined by the polymeric backbone 1101 and crosslinks 1102 for different crosslink densities. The crosslink density of the three-dimensional networks are 50%, 60% and 70%, respectively for FIGS. 11a, 11b and 11c. The number of crosslinks 1102 and the interconnectedness increases with increasing crosslinking densities. Now with reference to FIGS. 2-9, the increase in the densification of the crosslinking reduces the void diameter in the polymeric coating layer 110, which is smaller than the diameter of gyration of the plasticizer molecules 108. Thus, the adhesive layer 107 does not liquefy. The coating layer 110 then functions as a mechanical barrier to inhibit the migration of the plasticizer molecules 108 from the core layer 102 to the adhesive layer 107. FIG. 11d shows a reference figure of the crosslink densities as shown in FIGS. 11a-11c wherein the effect of the increased crosslinked density is shown.

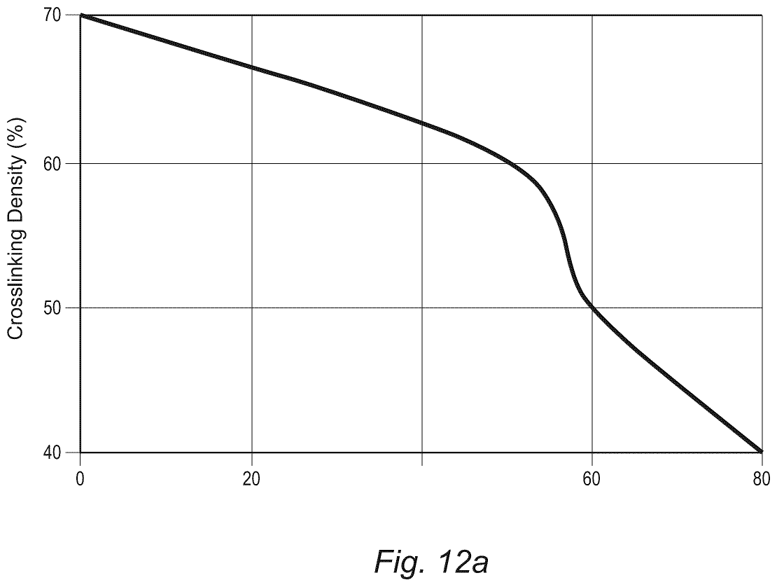

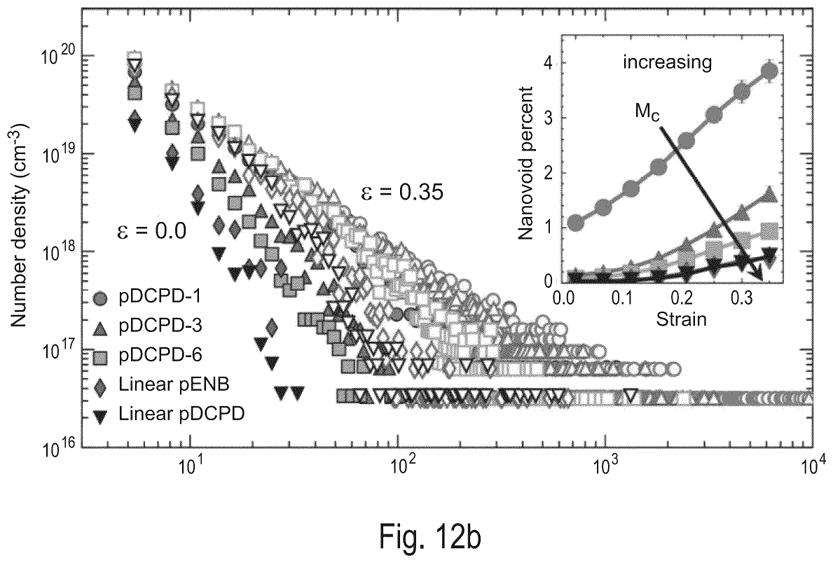

FIG. 12a shows the relationship of the crosslinking density with the void diameter, such that the crosslinking density is inversely proportional with the void diameter of the polymeric network of the coating layer. The figure shows that a drastic decrease in the void diameter is due to the increase of the crosslinking density on the coating layer. In a densely crosslinked network, the formation of voids is less likely, and the void diameter tends to be smaller. As the crosslinking density decreases, the network becomes less connected, allowing the formation of larger voids.

Additionally, the size and distribution of voids can be influenced by the polymer's molecular weight, the degree of crosslinking, and the presence of any plasticizers or other additives. The network topology, such as the arrangement of crosslinks, also plays a role in determining the void structure.

FIG. 12b is a reference figure showing histograms of nanovoid volumes in poly(dicyclopentadiene) (pDCPD) and poly(5-ethylidene-2-norbornene) (pENB) undergoing uniaxial extension deep in the glassy state (150 K) at 0% (solid symbols) and 35% (open symbols) engineering strain. Inset shows the nanovoid volume percent, i.e., the percent of the simulation box volume occupied by nanovoids.

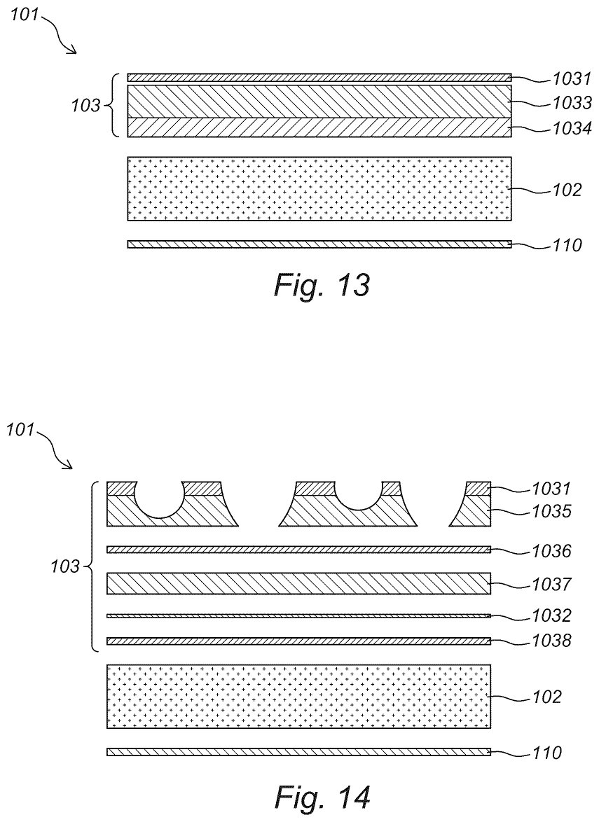

FIG. 13 shows a schematic, exploded view of another possible embodiment of a panel 101 according to the invention. It is conceivable that the top layer 103 of the panel comprises at least one top coating layer 1031, at least one tactile or texture layer 1033, and (optionally) at least one wear layer 1034. The top layer 103 is provided at least partially on a top surface of a core 102, and a coating layer 110 is provided on the bottom surface of a core layer 102. The thickness of the at least one wear layer is at least 0.2 mm, most preferably up to 0.5 mm. It is conceivable that at least two wear layers are provided, where it is conceivable that wear resistant particles are provided between two wear layers at a weight of 20-50 g/m2, preferably at around 30-35 g/m2.

FIG. 14 shows a schematic, exploded view of an alternative embodiment of a panel 101 according to the invention, and in particular a top layer 103 of the panel. The panel comprises a top layer 103 which comprises a coating layer 1031, at least one texture or embossing layer 1035, a gloss control layer 1036, an acrylic coating layer 1037 comprising wear resistant particles at a load of 5-15% by weight, a decorative print layer 1032, and a primer layer 1038. The at least one acrylic coating layer 1037 may also comprise scattered wear resistant particles. The embossing layer 1035 can be a viscoelastic coating layer. The decorative print layer 1032 is alternatively a digitally printed layer. The top layer 103 is provided at least partially on a top surface of a core 102, and an optional coating layer 110 is provided on the bottom surface of a core layer 102.

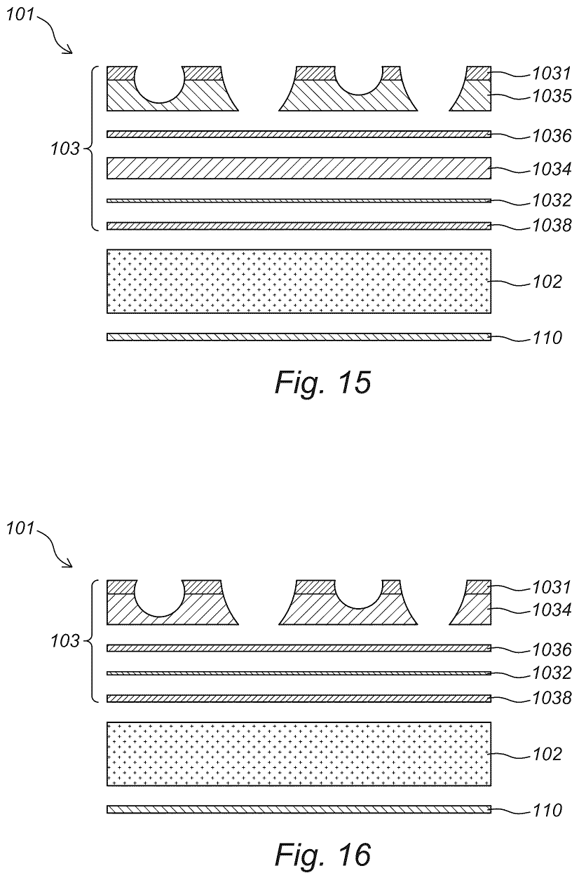

FIG. 15 shows a schematic, exploded view of an alternative embodiment of panel 101 according to the invention, and in particular a possible embodiment of a top layer 103 according to the present invention. The panel 101 comprises a top layer 103 which alternatively comprises a top coating layer 1031, at least one embossing layer 1035, a gloss control layer 1036, at least one wear layer 1034, where it is conceivable that at least two wear layers are provided and/or that a ceramic bead load is provided between at least two wear layers at a weight of 20-50 g/m2, preferably at around 30-35 g/m, a decorative print layer 1032, and/or a primer layer 1038. Embossing is at least partially provided on the top layer 103 by mechanical, chemical or abrasive means, where the top coating layer 1031 covers at least part of the embossing layer 1035. The top layer 103 is provided at least partially on a top surface of a core 102, and an optional coating layer 110 is provided on the bottom surface of a core layer 102.

FIG. 16 shows yet another schematic, exploded view of an alternative embodiment of a panel 101 according to the invention, and in particular a top layer 103 of the panel. The panel comprises a top layer 103 which alternatively comprises a top coating layer 1031, at least one embossing layer 1034, a gloss control layer 1036, a decorative print layer 1032, and/or a primer layer 1038. Embossing is at least partially provided on the top layer 103, specifically extending vertically in the embossing layer 1034, wherein the top coating layer 1031 covers at least part of the embossing layer 1034. The top layer 103 is provided at least partially on a top surface of a core 102, and an optional coating layer 110 is provided on the bottom surface of a core layer 102.

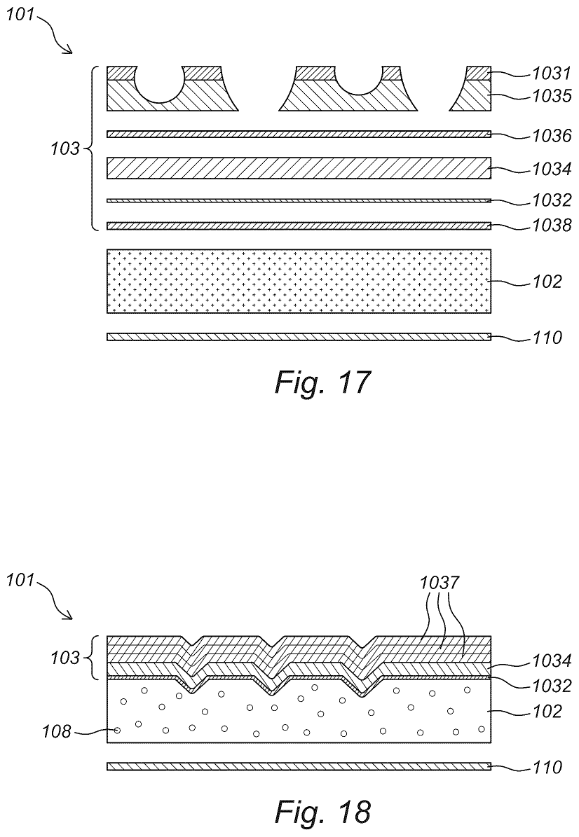

FIG. 17 shows a schematic, exploded view of an alternative embodiment of panel 101 according to the invention, and in particular the top layer 103 of the panel 101. The panel 101 comprises a top layer 103 which preferably comprises a top coating layer 1031, at least one embossing layer 1035, a gloss control layer 1036, a wear layer 1034, a decorative print layer 1032 and/or a primer layer 1038. The thickness of the at least one wear layer 1034 is at least 0.2 mm, most preferably up to 0.5 mm. It is conceivable that at least part of the at least one embossing layer 1035 and/or the gloss control layer 1036 is covered with the top coating layer 1031. It is further conceived that the embossing layer 1035 is a viscoelastic coating layer and that the decorative print layer 1032 is a digitally printed layer. The top layer 103 is provided at least partially on a top surface of a core 102, and an optional coating layer 110 is provided on the bottom surface of a core layer 102.

FIG. 18 shows a schematic, exploded view of an alternative embodiment of panel 101 according to the invention, and in particular the top layer 103 of the panel 101. The panel 101 comprises a top coating layer 103 which preferably comprises at least one acrylic coating layer 1037, a decorative print layer 1032 and/or at least one wear layer 1034. The thickness of the at least one wear layer is at least 0.2 mm, most preferably up to 0.5 mm. It is conceivable that embossing is applied to at least part of the acrylic coating layer 1037 to at least part of the decorative print layer 1032 and/or to at least part of the core layer 102. The core layer 102 comprises plasticizer molecules 108. The top layer 103 is provided at least partially on a top surface of a core 102, and an optional coating layer 110 is provided on the bottom surface of a core layer 102. It is further conceived that the at least one acrylic coating layer 1037 contains wear-resistant particles in the range of 1% to 30%, preferably in the range of 1% to 10%.

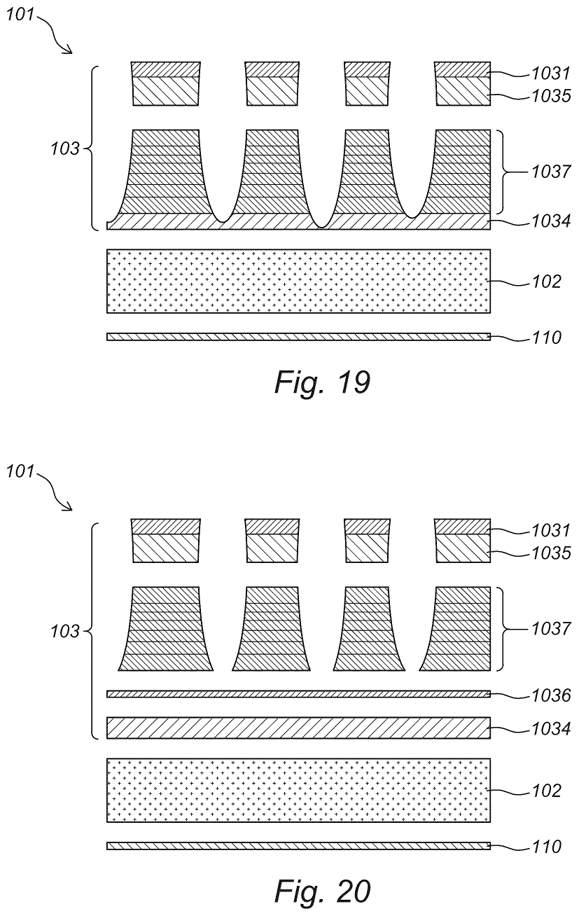

FIG. 19 shows a schematic, exploded view of an alternative embodiment of panel 101 according to the invention, and in particular the top layer 103 of the panel 101. The panel 101 comprises a top layer 103 which preferably comprises a top coating layer 1031, at least one embossing layer 1035, a plurality of acrylic coating layers 1037 and/or a wear layer 1034. The thickness of the at least one wear layer 1034 is at least 0.2 mm, most preferably up to 0.5 mm. It is conceivable that embossing is applied to at least part of the embossing layer 1035, at least one acrylic coating layer 1037 and/or to at least part of the wear layer 1034. It is further conceived that at least part of the at least one embossing layer 1035, at least one acrylic coating layer 1037 and/or wear layer 1034 is covered with the top coating layer 1031. It is also conceived that the at least one acrylic coating layer 1037 contains wear-resistant particles in the range of 1% to 30%, preferably in the range of 1% to 10%. The top layer 103 is provided at least partially on a top surface of a core 102, and an optional coating layer 110 is provided on the bottom surface of a core layer 102.

FIG. 20 shows a schematic, exploded view of an alternative embodiment of a panel 101 according to the invention, and in particular the top layer 103 of the panel 101. The panel 101 comprises a top layer 103 which preferably comprises a top coating layer 1031, at least one embossing layer 1035, a plurality of acrylic coating layers 1037, a gloss control layer 1036 and/or a wear layer 1034. The thickness of the at least one wear layer 1034 is at least 0.2 mm, most preferably up to 0.5 mm. It is conceivable that embossing is applied to at least part of the embossing layer 1035, and/or to at least part of the acrylic coating layer 1037. It is further conceived that at least part of the at least one embossing layer 1035 and/or the at least one acrylic coating layer 1037 is covered with the top coating layer 1031. It is also conceived that the at least one acrylic coating layer 1037 contains wear-resistant particles in the range of 1% to 30%, preferably in the range of 1% to 10%. The top layer 103 is provided at least partially on a top surface of a core 102, and an optional coating layer 110 is provided on the bottom surface of a core layer 102.

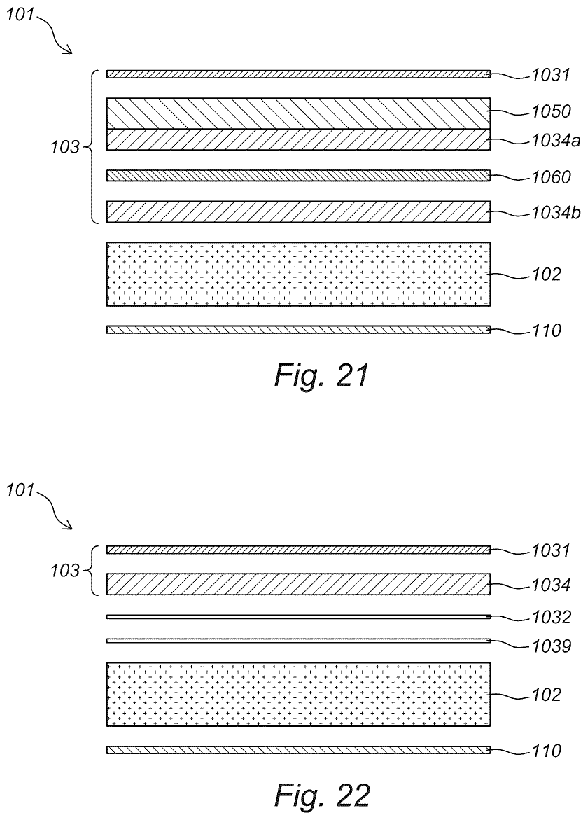

FIG. 21 shows another schematic, exploded view of an alternative embodiment of a panel 101 according to the present invention. The panel 101 comprises top layer 103, further comprising a thin top coating 1031, at least one embossing layer 1050, at least one first wear layer 1034a, and/or at least one second wear layer 1034b. At least one scatting layer 1060, for example an aluminium oxide scattering layer can be provided below at least one first wear layer 1034a, and/or above at least one second wear layer 1034b. The wear resistant particles may be scattered, at least partially enclosed or embedded, preferably completely enclosed or embedded, by the at least one first wear layer 1034a and the at least one second wear layer 1034b after being adhered to each other. The top layer 103 is provided at least partially on a top surface of a core 102, and an optional coating layer 110 is provided on the bottom surface of a core layer 102.

FIG. 22 shows a schematic, exploded view of an alternative embodiment of a panel 101 according to the invention. The panel 101 comprises a top layer 103, a core layer 102, and at least one coating layer 110. The top layer 103 alternatively comprises a top coating layer 1031, at least one wear layer 1034, and a decorative print layer 1032. It is conceivable that the at least one wear layer 1034 has a thickness between 0.2 to 0.5 mm. It is further conceivable that decorative print layer 1032 is a digitally printed layer and/or an impregnated paper layer. If an impregnated paper layer is used, then an overlay layer 1039 is added in between the impregnated paper and the core layer 102, preferably adjacent to the impregnated paper.

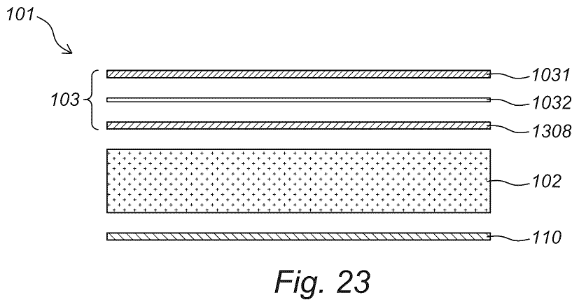

FIG. 23 shows a schematic, exploded view of an alternative embodiment of a panel 101 according to the invention. The panel 101 comprises a top coating layer 103, a core layer 102, and at least one coating layer 110. The top layer 103 comprises a top coating layer 1031, a digital printed layer 1032, and a primer layer 1308.

It will be apparent that the invention is not limited to the working examples shown and described herein, but that numerous variants are possible within the scope of the attached claims that will be obvious to a person skilled in the art.

The verb “comprise” and conjugations thereof used in this patent publication are understood to mean not only “comprise”, but are also understood to mean the phrases “contain”, “substantially consist of”, “formed by” and conjugations thereof.

1. A floor panel or wall panel, comprising:
at least one core layer comprising at least one mineral filler, at least one polymeric binder, and at least one plasticizer;
at least one decorative top layer located on a top surface of the at least one core layer, said at least one decorative top layer comprising at least one printed layer, at least one wear layer and at least one top coating layer; and
at least one bottom coating layer located on a bottom surface of the at least one core layer;
wherein the at least one printed layer is at least partially digitally printed;
wherein the at least one wear layer has a thickness in the range of 0.2 mm to 0.8 mm and comprises one or more transparent layers of a thermoplastic or thermosetting resin;
wherein the at least one top coating layer comprises at least one viscoelastic coating layer, at least one thermoset coating, at least one acrylic coating layer, at least one excimer cured coating layer or any combination thereof, and comprises at least partially a tactile texture provided thereon by chemical or mechanical means; and
wherein the at least one bottom coating layer comprises an at least partly crosslinked polymer impermeable to the at least one plasticizer.

2. The panel according to claim 1, wherein the at least one bottom coating layer has a shrinking rate A when tested according to ISO 23999 and wherein the at least one top coating layer and/or decorative top layer has a shrinking rate B when tested according to ISO 23999, wherein B<A and/or wherein A≈1.1·B.

3. The panel according to claim 1, wherein a thickness of the at least one decorative top layer is in the range of 0.05 mm to 0.10 mm.

4. The panel according to claim 1, wherein the at least one decorative top layer forms integral part of the at least one core layer.

5. The panel according to claim 1, wherein a primer is provided on a top facing surface of the at least one core layer.

6. The panel according to claim 1, wherein a coating layer is provided on a top facing surface of the at least one core layer.

7. The panel according to claim 1, wherein the at least partially crosslinked polymer has a crosslinking density of at least 50%.

8. The panel according to claim 1, wherein the at least one bottom coating layer comprises 30-50 wt. % of at least one acrylate oligomer, 10-20 wt. % of at least one acrylate monomer, and 1-5 wt. % of at least one photoinitiator.

9. The panel according to claim 8, wherein the at least one acrylate oligomer is selected from urethane acrylate oligomers, polyester-based urethane acrylate oligomers, aliphatic urethane acrylate oligomers, aromatic urethane acrylate oligomers, polyether-based urethane acrylate oligomers, waterborne urethane acrylate oligomers, polyester acrylate oligomers, unsaturated polyester acrylates, polyester acrylates, adhesion-promoting polyester acrylates, low-molecular weight polyester acrylates, water-reducible polyester acrylates, epoxy acrylate oligomers, bisphenol A epoxy acrylates, aliphatic epoxy acrylates, cycloaliphatic epoxy acrylates, low-viscosity epoxy acrylates, novolac epoxy acrylates, silicone acrylate oligomers, hydrophilic silicone acrylates, silicone acrylates, silicone-modified acrylates, low-viscosity silicone acrylates, silicone-modified urethane acrylate, or any combination thereof.

10. The panel according to claim 8, wherein the at least one acrylate monomer is selected from tetrahydrofurfuryl acrylate, pentaerythritol triacrylate, 2-hydroxyethyl acrylate (HEA), ethoxylated bisphenol A diacrylate (EBDA), trimethylolpropane triacrylate (TMPTA), isobornyl acrylate (IBOA), cyclohexyl acrylate (CHA), or any combination thereof.

11. The panel according to claim 1, wherein the at least one core layer comprises 10-40 wt. % of the at least one polymeric binder, 20-60 wt. % of the at least one mineral filler, and at least 4 wt. %, of the at least one plasticizer, based on total weight of the at least one core layer.

12. The panel according to claim 1, wherein the at least one plasticizer is selected from diisononyl phthalate (DINP), diisodecyl phthalate (DIDP), diethylhexyl phthalate (DEHP), dibutyl phthalate (DBP), butyl benzyl phthalate (BBP), di(2-ethylhexyl) adipate (DEHA), di(2-ethylhexyl) sebacate (DOS), di(2-ethylhexyl) terephthalate (DOTP), diisononyl cyclohexane-1,2-dicarboxylate (DINCH), triethyl citrate (TEC), di(2-ethylhexyl) phthalate (DEHP), di-n-octyl phthalate (DNOP), diisobutyl phthalate (DIBP), di-n-hexyl phthalate (DNHP), diethyl phthalate (DEP), dicyclohexyl phthalate (DCHP), diethylene glycol dibenzoate (DEDB), epoxidized soybean oil (ESBO), citrates, citrate esters, castor oil derivatives, epoxidized vegetable oils, succinic acid esters, tartaric acid, sorbitol, polyethylene glycol, starch, epoxidized soybean oil (ESBO), tributyl citrate (TBC), acetyl tributyl citrate (ATBC), triethyl citrate A (TEC-A), triclocarban (TCC), bis(2-ethylhexyl) maleate, bis(2-ethylhexyl) fumarate, DOML (linseed oil), DOP (castor oil based), DEHT (castor oil), GEFA, ELO, ESO, EVO, ELOV, ELOVAT, DOSA, DOA, DIDA, DES, DBS, PEG, Lactic Acid, Oleic acid, PPG, PES, Paraffinic oils, naphthenic oils, esters, or any combination thereof.

13. The panel according to claim 1, wherein the at least one polymeric binder is selected from polypropylene (PP), polyethylene terephthalate (PET), polyvinyl chloride (PVC), chlorinated polyvinyl chloride (CPVC), chlorinated polyethylene (CPE), Polylactic Acid (PLA), Polyhydroxyalkanoates (PHA), Polybutylene Succinate (PBS), Polyhydroxyurethane (PHU), Cellulose Acetate (CA), Starch-based Bioplastics, Polyglycolic Acid (PGA), Polyhydroxyalkanoate-Co-Valerate (PHA-V), Polybutylene Adipate Terephthalate (PBAT), TPU, LDPE, LLDPE, HDPE, PS, HIPS, GPPS, PA, PETG, PPC, PC, ABS, PVDF, starch-based polymers, PHD, Bio-PE, LA, cellulose acetate, or any combination thereof.

14. The panel according to claim 1, wherein at least one mineral material comprises magnesium oxide, magnesium carbonate, magnesium oxysulphate, magnesium oxychloride cement (MOC), magnesium chloride (MgCl2), magnesium sulphate (MgSO4), Sorel cement, fiber cement, MOS cement, limestone, calcium carbonate, calcite mineral, stone, chalk, clay, calcium silicate and/or talc.

15. A method of manufacturing a floor panel or wall panel, comprising the steps of:
providing at least one core layer comprising at least one mineral filler, at least one polymeric binder, and at least one plasticizer;
providing at least one decorative top layer to a top surface of the at least one core layer, said at least one decorative top layer comprising at least one printed layer, at least one wear layer and at least one top coating layer; and
providing at least one bottom coating layer to a bottom surface of the at least one core layer;
wherein the at least one wear layer has a thickness in the range of 0.2 mm to 0.8 mm and comprises one or more transparent layers of a thermoplastic or thermosetting resin;
wherein the at least one top coating layer comprises at least one viscoelastic coating layer, at least one thermoset coating, at least one acrylic coating layer, at least one excimer cured coating layer or any combination thereof, and comprises at least partially a tactile texture provided thereon by chemical or mechanical means; and
wherein the at least one bottom coating layer comprises an at least partly crosslinked polymer impermeable to the at least one plasticizer.

16. The method according to claim 15, wherein a mass of the composition is applied to the bottom surface of the core layer in a range between 10 and 90 g/m2.

17. The method according to claim 15, wherein the at least one core layer comprises 10-40 wt. % of the at least one polymeric binder, 20-60 wt. % of the at least one mineral filler, and at least 4 wt. %, of the at least one plasticizer, based on total weight of the at least one core layer.

18. The method according to claim 15, wherein the at least one bottom coating layer has a shrinking rate A when tested according to ISO 23999 and wherein the at least one top coating layer and/or decorative top layer has a shrinking rate B when tested according to ISO 23999, wherein B<A and/or wherein A≈1.1·B.

19. The method according to claim 15, wherein a thickness of the at least one decorative top layer is in the range of 0.05 mm to 0.10 mm.

20. The method according to claim 15, wherein the printed layer is a digitally printed layer.
